(19) United States
(12) Patent Application Publication
(10) Pub. No.: US 2026/0062229 A1
(43) Pub. Date: Mar. 5, 2026

(54) PARTICULATE COLLECTION SYSTEM

(71) Applicant: Legends Equipment, Dayton, KY (US)

(72) Inventor: Brian E. Limbacher, Union, KY (US)

(73) Assignee: Legends Equipment, Dayton, KY (US)

(21) Appl. No.: 19/308,643

(22) Filed: Aug. 25, 2025

Related U.S. Application Data
(60) Provisional application No. 63/687,360, filed on Aug. 27, 2024.
(60) Provisional application No. 63/774,878, filed on Mar. 20, 2025.

(51) Int. Cl. B65G 45/26; B01F 29/25; B01F 29/62; B08B 5/04

(52) U.S. Cl. CPC B65G 45/26; B01F 29/25; B01F 29/62; B08B 5/04

(57) ABSTRACT

A particulate collection system for use in a production environment. The particulate collection system includes a chute that collects and funnels dust, or other fine particulates, towards an exit opening. Proximal to the exit opening is a hollow stationary enclosure, and a hollow inner rotatable housing positioned inside the hollow stationary enclosure. The hollow stationary enclosure exhibits a first plurality of longitudinal openings, and the hollow inner rotatable housing exhibits a second plurality of spaced-apart openings along a wall of the rotatable housing. As the dust is funneled through the chute, the dust passes through the first plurality of longitudinal openings and the second plurality of spaced-apart openings, wherein the hollow inner rotatable housing temporarily collects the dust. The particulate collection system has a motor that rotates the hollow inner rotatable housing, and an external vacuum system that removes the collected particulates.

### CROSS-REFERENCE TO RELATED APPLICATIONS

The present application claims priority to provisional patent application Ser. No. 63/687,360, titled “PARTICULATE COLLECTION SYSTEM,” filed on Aug. 27, 2024, and claims priority to provisional patent application Ser. No. 63/774,878, titled “PARTICULATE COLLECTION SYSTEM,” filed on Mar. 20, 2025.

### TECHNICAL FIELD

The technology disclosed herein relates generally to particulate collection systems and is particularly directed to dust collection systems of the type that are used to collect dust from a conveyor belt. Embodiments are specifically disclosed as using a chute to collect and funnel dust towards an outer stationary enclosure and an inner rotatable housing positioned inside the outer stationary enclosure. The outer stationary enclosure has a plurality of longitudinal openings, and the inner rotatable housing has a plurality of spaced-apart openings along the inner rotatable housing wall. The outer enclosure and inner housing are both connected to an external vacuum system, such that, when the external vacuum system is actuated, the collected dust is removed from the inner rotatable housing.

Another embodiment is disclosed involving the dust collection system used to collect, mix, and transport different types of particulates from a mixer system. The mixer system separately funnels different material types into the chute, which will then be collected and mixed inside of the outer stationary enclosure and the inner rotatable housing. The external vacuum system can then either transport the newly mixed materials into a nearby storage container, or transport the materials to a remote location for easier pickup and transport.

A further embodiment is disclosed in which the inner rotatable housing wall exhibits different spaced-apart opening shapes. The plurality of spaced-apart openings can be comprised of different geometric shapes, depending on the type of particulate that needs to be collected with the collection system.

### STATEMENT REGARDING FEDERALLY SPONSORED RESEARCH OR DEVELOPMENT

None.

### BACKGROUND

Typical conveyor belt collection systems utilize a scraper in conjunction with a large hood chute. The chute includes a waste bin, and the bin must be periodically emptied by a human user. One alternative conveyor belt collection system uses a brush to physically roll along and clean the conveyor belt itself. Sometimes these brush systems may have a vacuum system with a waste bin to further collect dust from the brushes.

Typical industrial mixing systems usually mix dry chemicals or dry food ingredients together, and then funnel the newly mixed material into a bin. That bin then needs to be manually transported to the next location in the process, which lengthens the time of production.

### SUMMARY

Accordingly, it is an advantage to provide a particulate collection system in which a chute is used to collect and funnel particulates through a plurality of tubes and into an external bin.

It is another advantage to provide a particulate collection system in which particulates are collected and funneled through a chute, the chute is mounted proximal to a plurality of tubes in which a first outer non-rotating tube includes a second inner rotating tube, the first tube has a first plurality of spaced-apart openings and the second tube has a second plurality of spaced-apart openings, a motor in mechanical communication with the second tube, and a hose that connects the collection system to an external bin.

It is yet another advantage to provide a particulate collection system in which particulates are collected and funneled through a chute, the chute is mounted proximal to a plurality of tubes in which a first outer non-rotating tube includes a second inner rotating tube, the first tube has a first plurality of spaced-apart openings and the second tube has a second plurality of spaced-apart openings, and the second plurality of spaced-apart openings exhibits a geometric shape to allow dust to travel through.

It is still another advantage to provide a particulate collection system in which a chute is used to collect and funnel particulates through a plurality of tubes and into an external bin, such as a central vacuum system.

It is a further advantage to provide a particulate collection system having a smaller open area, in which the amount of air needed to vacuum particulates is reduced, while the vacuum velocity is simultaneously increased.

Additional advantages and other novel features will be set forth in part in the description that follows and in part will become apparent to those skilled in the art upon examination of the following or may be learned with the practice of the technology disclosed herein.

To achieve the foregoing and other advantages, and in accordance with one aspect, a particulate collection system is provided, which comprises: a hollow stationary enclosure exhibiting at least one longitudinal opening; a hollow rotatable housing exhibiting at least one opening along a wall of the hollow rotatable housing, the hollow rotatable housing being positioned inside the hollow stationary enclosure; a chute exhibiting a bottom opening, the bottom opening of the chute being mounted proximal to the at least one opening of the hollow stationary enclosure; a motor mount; a motor secured to the motor mount, the motor exhibiting a port for connection to an external power source; a hose mount that is proximal to an open first end of the hollow rotatable housing, the hose mount allowing for a connection with an external hose to create a pneumatic communication with an external vacuum system; and the motor being mounted proximal to a second, opposite end of the hollow rotatable housing, the motor being in mechanical communication with the hollow rotatable housing.

In accordance with another aspect, a particulate collection system is provided, which comprises: a hollow stationary enclosure exhibiting at least one longitudinal opening; a hollow rotatable housing exhibiting at least one opening along a sleeve of the hollow rotatable housing, the hollow rotatable housing positioned inside the hollow stationary enclosure; a motor mount; a motor secured to the motor mount, the motor exhibiting a port for connection to an external power source; a hose that, during operation, is mounted proximal to an open first end of the hollow rotatable housing, in which, during operation, the hose is in pneumatic communication with an external vacuum system; the motor is mounted proximal to a second, opposite end of the hollow rotatable housing, and the motor is in mechanical communication with the hollow rotatable housing; the hollow stationary enclosure exhibiting a first opening proximal to the first end of the hollow rotatable housing; and the hollow stationary enclosure exhibiting a second opening proximal to the second end of the hollow rotatable housing.

In accordance with a further aspect, a method for collecting particulates is provided, in which the method comprises: providing a particulate collection system, including: a hollow stationary enclosure; a hollow rotatable housing positioned inside the hollow stationary enclosure; a motor mount; a motor secured to the motor mount, the motor being connected to an external power source; a hose mounted proximal to an open first end of the hollow rotatable housing, in which the hose is in pneumatic communication with an external vacuum system; the motor mounted proximal to a second, opposite end of the hollow rotatable housing, and the motor is in mechanical communication with the hollow rotatable housing; the hollow stationary enclosure exhibiting at least one longitudinal opening on an upper portion of the hollow stationary enclosure; and the hollow rotatable housing exhibiting a plurality of spaced-apart openings along the wall of the hollow rotatable housing; actuating the external vacuum system; actuating the motor; rotating, by use of the motor, the hollow rotatable housing; collecting, using the hollow rotatable housing, particulates that drop through the plurality of longitudinal openings of the hollow stationary enclosure and that also drop through the plurality of spaced-apart openings of the hollow rotatable housing; and removing, using the external vacuum system, the collected particulates through the hose.

In accordance with a yet further aspect, a particulate collection system is provided, which comprises: a hollow stationary enclosure exhibiting at least one longitudinal opening; a hollow rotatable housing exhibiting a plurality of openings that are spaced-apart along a wall of the hollow rotatable housing, the hollow rotatable housing being positioned inside the hollow stationary enclosure; a chute exhibiting a bottom opening, the bottom opening of the chute being mounted proximal to the at least one longitudinal opening of the hollow stationary enclosure; at least one lower cradle that supports the hollow rotatable housing; at least one upper filler that confines the hollow rotatable housing against the at least one cradle; a motor mount; a motor secured to the motor mount, the motor exhibiting a port for connection to an external power source; a hose mount that is proximal to an open first end of the hollow rotatable housing, the hose mount allowing for a connection with an external hose to create a pneumatic communication with an external vacuum system; and the motor being mounted proximal to a second, opposite end of the hollow rotatable housing, the motor being in mechanical communication with the hollow rotatable housing; wherein: the hollow rotatable housing, the at least one lower cradle, and the at least one upper filler together form an essentially air-tight configuration inside the hollow stationary enclosure; and when the external vacuum system is actuated, a vacuum flow travels through the bottom opening of the chute, the at least one longitudinal opening of the hollow stationary enclosure, and only through a portion of the plurality of openings of the hollow rotatable housing that are instantaneously aligned with the bottom opening of the chute.

In accordance with another aspect, a particulate collection system is provided, which comprises: a hollow stationary enclosure exhibiting at least one longitudinal opening; a chute exhibiting a bottom opening, the bottom opening of the chute being mounted proximal to the at least one opening of the hollow stationary enclosure; at least one sliding plate that exhibits a plurality of spaced-apart openings, the at least one sliding plate is positioned between the bottom opening of the chute and the at least one longitudinal opening of the hollow stationary enclosure; a hose mount that is proximal to a first end of the hollow stationary enclosure, the hose mount allowing for a connection with an external hose to create a pneumatic communication with an external vacuum system; the at least one sliding plate reciprocates along the at least one longitudinal opening; during operation, when particulates enter the chute, the particulates drop through the at least one plurality of spaced-apart openings of the at least one sliding plate and the at least one longitudinal opening of the hollow stationary enclosure; and the vacuum flow of the external vacuum system then removes the particulates from the hollow stationary enclosure, through the hose.

In accordance with yet another aspect, a particulate collection system is provided, which comprises: a chute exhibiting a bottom opening, the bottom opening of the chute being mounted proximal to a hollow stationary enclosure; a hollow rotatable housing exhibiting at least one opening along a wall of the hollow rotatable housing, the hollow rotatable housing being positioned inside the hollow stationary enclosure; a motor secured to a motor mount, the motor exhibiting a connection to an external power source; a coupler mounted proximal to a second, opposite end of the hollow rotatable housing, the coupler being in mechanical communication with the hollow rotatable housing and the motor; a hose mount that is proximal to an open first end of the hollow rotatable housing, the hose mount allowing for a connection with an external hose to create a pneumatic communication with an external vacuum system; and the hollow rotatable housing can be rotated to a position that seals the bottom opening of the chute, such that particulates can not drop through the at least one opening along a wall of the hollow rotatable housing.

Still other advantages will become apparent to those skilled in this art from the following description and drawings wherein there is described and shown a preferred embodiment in one of the best modes contemplated for carrying out the technology. As will be realized, the technology disclosed herein is capable of other different embodiments, and its several details are capable of modification in various, obvious aspects all without departing from its principles. Accordingly, the drawings and descriptions will be regarded as illustrative in nature and not as restrictive.

### BRIEF DESCRIPTION OF THE DRAWINGS

The accompanying drawings incorporated in and forming a part of the specification illustrate several aspects of the technology disclosed herein, and together with the description and claims serve to explain the principles of the technology. In the drawings:

FIG. 1 is an exploded view of the major components of a particulate collection system, as constructed according to the principles of the technology disclosed herein.

FIG. 2 is a top left front perspective view of the particulate collection system of FIG. 1.

FIG. 3 is a top right rear perspective view of the particulate collection system of FIG. 1.

FIG. 4 is a front elevational view of the particulate collection system of FIG. 1.

FIG. 5 is a left elevational view of the particulate collection system of FIG. 1.

FIG. 6 is a cutaway view along the line 6-6 of FIG. 5.

FIG. 7 is a top view of the particulate collection system of FIG. 1, showing the inner rotating tube in an initial position during rotation.

FIG. 8 is a top view of the particulate collection system of FIG. 1, showing the inner rotating tube in a second position as rotation continues.

FIG. 9 is a top view of the particulate collection system of FIG. 1, showing the inner rotating tube in a third position as further rotation occurs.

FIG. 10 is a top view of the particulate collection system of FIG. 1, showing the inner rotating tube in a fourth position as rotation continues.

FIG. 11 is a top view of the particulate collection system of FIG. 1, showing the inner rotating tube in a fifth position during rotation.

FIG. 12 is a top view of the particulate collection system of FIG. 1, showing the inner rotating tube in a sixth position as rotation continues.

FIG. 13 is a top view of the particulate collection system of FIG. 1, showing the inner rotating tube in a seventh position as further rotation occurs.

FIG. 14 is a top view of the particulate collection system of FIG. 1, showing the inner rotating tube in an eight position during rotation.

FIG. 15 illustrates the particulate collection system of FIG. 1 mounted to a typical conveyor belt.

FIG. 16 depicts a first alternative embodiment particulate collection system, in which a human user is manually sweeping dust into the particulate collection system.

FIG. 17 depicts the first alternative embodiment particulate collection system without a floor cover.

FIG. 18 depicts a second alternative embodiment particulate collection system, in which a first mixer sub-assembly is depositing particulates into the collection system.

FIG. 19 depicts a third alternative embodiment particulate collection system, in which a second mixer sub-assembly is depositing particulates into the collection system.

FIG. 20A depicts the inner rotatable housing of the particulate collection system of FIG. 1, showing a first type of plurality of openings in the inner rotatable housing wall.

FIG. 20B depicts a fourth alternative embodiment inner rotatable housing of the particulate collection system, showing a second type of plurality of openings in the inner rotatable housing wall.

FIG. 20C depicts a fifth alternative embodiment inner rotatable housing of the particulate collection system, showing a third type of plurality of openings in the inner rotatable housing wall.

FIG. 21 depicts a block diagram showing some of the mechanical systems used to collect dust and particulates using the particulate collection system of FIG. 1.

FIG. 22 depicts an exploded view of a sixth alternative embodiment particulate collection system.

FIG. 23 depicts a top right rear perspective view of the particulate collection system of FIG. 22.

FIG. 24 depicts a similar perspective view as in FIG. 23, showing a portion of the chute as see-through.

FIG. 25 depicts a cutaway view along the line 25-25 of FIG. 26.

FIG. 26 depicts a partial cutaway view along a centerline of the stationary enclosure and the rotatable housing, of the particulate collection system of FIG. 22.

FIG. 27 depicts a cutaway view of the particulate collection system of FIG. 22.

FIG. 28 is a top plan view of a prior art particulate collection system opening.

FIG. 29 is a top plan view of the rotatable housing of the particulate collection system of FIG. 22.

FIG. 30 is an exploded view of a seventh alternative embodiment particulate collection system.

FIG. 31 is a top left front perspective view of the particulate collection system of FIG. 30.

FIG. 32 is a right elevational view of the particulate collection system of FIG. 31.

FIG. 33 is a front elevational view of the particulate collection system of FIG. 31.

FIG. 34 is a top view of the particulate collection system of FIG. 31, showing the sliding plates in a sealed or closed position.

FIG. 35 is a top view of the particulate collection system of FIG. 31, showing the sliding plates in a first open position.

FIG. 36 is a top view of the particulate collection system of FIG. 31, showing the sliding plates in a second open position.

FIG. 37 is a top view of the particulate collection system of FIG. 31, showing the sliding plates in a third open position.

FIG. 38 is a top left rear perspective view of an eighth alternative embodiment collection system.

FIG. 39 is a top view of the collection system of FIG. 38, showing the inner rotating housing in a sealed or closed position.

FIG. 40 is a right elevational view of the particulate collection system of FIG. 38.

FIG. 41 is an exploded view of the particulate collection system of FIG. 38.

### DETAILED DESCRIPTION

Reference will now be made in detail to the present preferred embodiment, an example of which is illustrated in the accompanying drawings, wherein like numerals indicate the same elements throughout the views.

It is to be understood that the technology disclosed herein is not limited in its application to the details of construction and the arrangement of components set forth in the following description or illustrated in the drawings. The technology disclosed herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” or “mounted,” and variations thereof herein are used broadly and encompass direct and indirect connections, couplings, or mountings. In addition, the terms “connected” or “coupled” and variations thereof are not restricted to physical or mechanical connections or couplings. Furthermore, the terms “communicating with” or “in communications with” refer to two different physical or virtual elements that somehow pass signals or information between each other, whether that transfer of signals or information is direct or whether there are additional physical or virtual elements therebetween that are also involved in that passing of signals or information. Moreover, the term “in communication with” can also refer to a mechanical, hydraulic, or pneumatic system in which one end (a “first end”) of the “communication” may be the “cause” of a certain impetus to occur (such as a mechanical movement, or a hydraulic or pneumatic change of state) and the other end (a “second end”) of the “communication” may receive the “effect” of that movement/change of state, whether there are intermediate components between the “first end” and the “second end,” or not. If a product has moving parts that rely on magnetic fields, or somehow detects a change in a magnetic field, or if data is passed from one electronic device to another by use of a magnetic field, then one could refer to those situations as items that are “in magnetic communication with” each other, in which one end of the “communication” may induce a magnetic field, and the other end may receive that magnetic field, and be acted on (or otherwise affected) by that magnetic field.

The terms “first” or “second” preceding an element name, e.g., first inlet, second inlet, etc., are used for identification purposes to distinguish between similar or related elements, results or concepts, and are not intended to necessarily imply order, nor are the terms “first” or “second” intended to preclude the inclusion of additional similar or related elements, results or concepts, unless otherwise indicated.

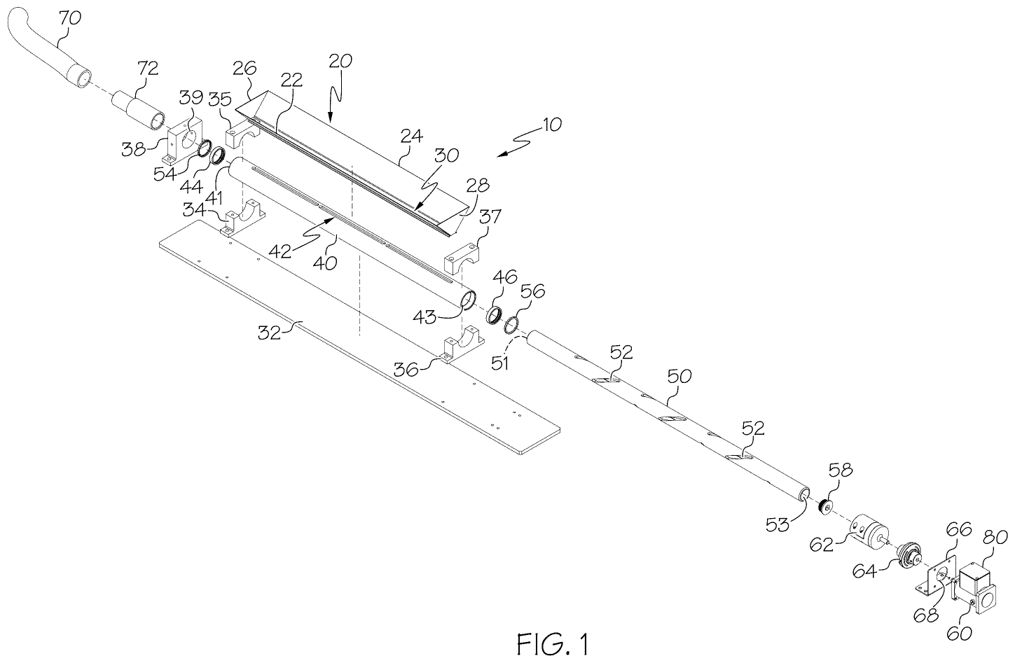

Referring now to FIG. 1, a collection system is generally designated by the reference numeral 10. The collection system 10 includes an elongated base 32 (also sometimes referred to herein as a “base plate”) with a first bottom support 34 and a second bottom support 36 separately mounted to the base 32. An outer stationary hollow tube 40 (also sometimes referred to herein as a “non-rotating tube” or a “stationary enclosure”) is positioned on the first bottom support 34 and the second bottom support 36, and secured to the base 32 by a first top support 35 and a second top support 37. The first top support 35 mounts directly onto the first bottom support 34, and the second top support 37 mounts directly onto the second bottom support 36.

The outer non-rotating tube 40 exhibits a plurality of longitudinal openings 42, a first opening 41 proximal to the first bottom support 34, and a second opening 43 proximal to the second bottom support 36. This plurality of longitudinal openings 42 are positioned on one side portion of the non-rotating tube 40, and are proximal to each other along the length of the non-rotating tube. A chute 20, exhibiting an opening 30, is mounted proximal to the non-rotating tube 40 such that the opening 30 is directly above the plurality of openings 42. The chute 20 includes a first ramp 22, a second opposite ramp 24, a first side 26, and a second opposite side 28.

An inner rotating hollow tube 50 (also sometimes referred to herein as a “rotating tube” or a “rotatable housing”) having a plurality of spaced-apart through-openings 52 along the tube's 50 cylindrical wall, or sleeve, is positioned inside the outer non-rotating tube 40. The rotatable housing 50 could be designed as any non-orthogonal shape, depending on the designer's desires, as long as the desired shape is rotatable. The rotating tube 50 exhibits a third opening 51 (sometimes referred to herein as a “first end”) proximal to the first bottom support 34 and a fourth opening 53 (sometimes referred to as a “second end”) proximal to the second bottom support 36. Depending on the desires of the designer, the second end could instead be a closed end. A first bearing 44 and a first seal 54 are positioned near the first opening 41, and the third opening 51 fits inside the inner diameter of both the first bearing 44 and the first seal 54. In a similar manner, a second bearing 46 and a second seal 56 are positioned near the second opening 43, and the fourth opening 53 fits inside the inner diameter of both the second bearing 46 and the second seal 56. The first bearing 44 and the second bearing 46 can be a needle bearing, for example.

A motor mount 66, exhibiting an opening 68, is mounted to the base 32 proximal to the second bottom support 36 and the second top support 37. A motor 60 is mounted on one side of the motor mount 66, and a torque limiter 64 along with a coupler 62 are both mounted on a second, opposite side of the motor mount 66. The motor 60 is in mechanical communication with the torque limiter 64 through the opening 68, and the torque limiter 64 is in mechanical communication with the coupler 62. The motor 60 includes a port 80 for an external power source, and this port 80 can be a receptacle, as one example, or an integrated power cable, as another example. The rotating tube 50 has a seal 58 that is in communication with the coupler 62, and the fourth opening 53 is in mechanical communication with the coupler 62. During operation, the motor 60 rotates the inner rotating tube 50.

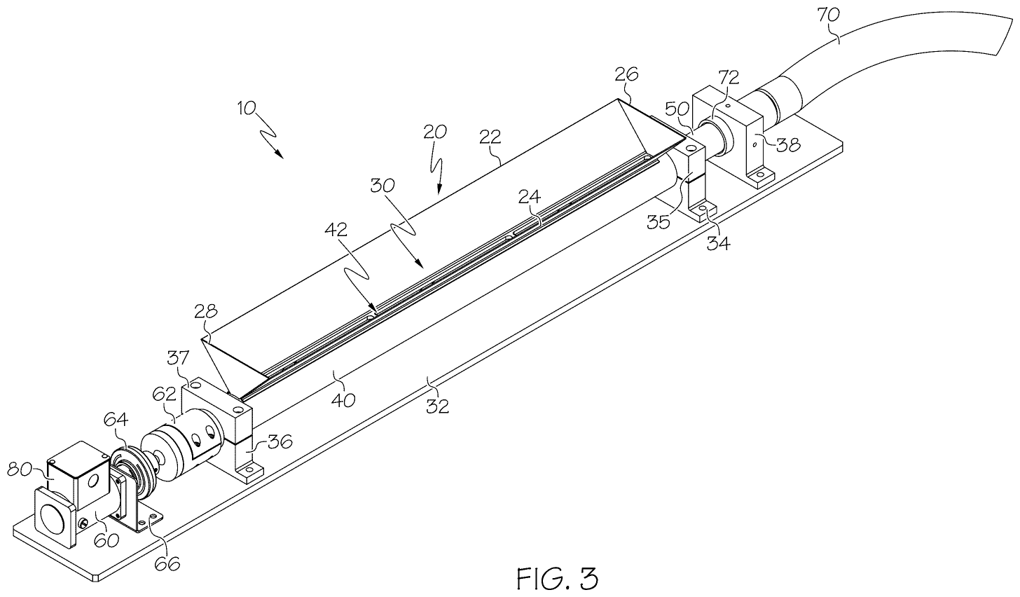

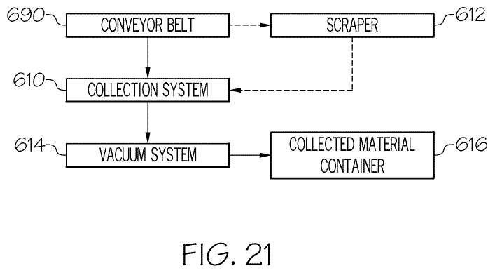

A support 38, exhibiting a through-hole 39, is mounted to the base 32 proximal to the first bottom support 34 and the first top support 35. An inlet 72 (also sometimes referred to herein as an “inlet adapter”) is positioned in the through-hole 39, and the third opening 51 fits inside the inner diameter of a first end of the inlet (see FIG. 3). A hose 70 fits over a second, opposite side of the inlet 72. The non-rotating tube 40, the rotating tube 50, the inlet 72, and the hose 70 are all in pneumatic communication with each other. The hose 70 is attached to a vacuum system 614 (see FIG. 21), such as a portable vacuum (such as a Shop Vac™) or a central vacuum system.

The particulate matter that is collected by conventional dust collecting systems typically requires a relatively strong air flow to move that particulate matter. This “air flow” is created by a device commonly referred to as a “vacuum collection system,” because the necessary air flow is created by a pressure that is below Earth's atmospheric pressure in order to collect such particulate matter a then to direct that matter into a given space. This type of “air flow” can also be referred to as a “vacuum flow.”

The particulate matter that is collected by the collection system described herein is ‘carried’ by a “vacuum flow” as such, and this vacuum flow represents an amount of air that can be moved over a period of time, which indicates how quickly the air can be suctioned. More specifically, the vacuum flow in the collection system described herein is designed to not only move a quantity of air, but also is designed to move a significant quantity of the particulate matter that is being collected. In a sense, the particulate matter is being ‘entrained’ by the vacuum flow.

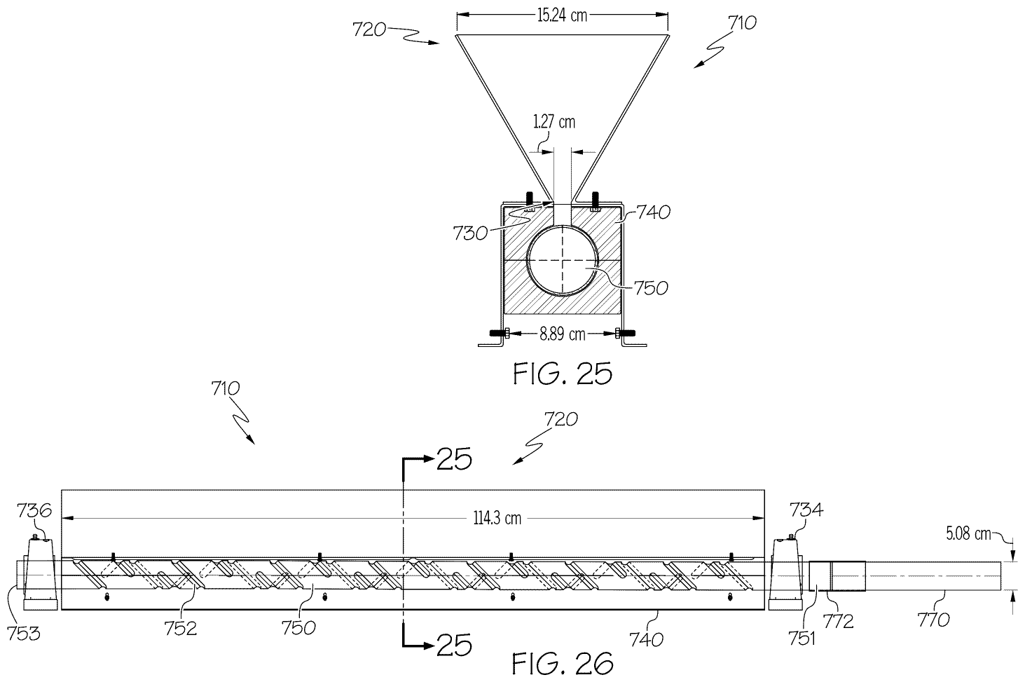

The collection system 10 is configured to reduce the amount of LPM (liters per minute; i.e., CFM (cubic feet per minute)) of air required to vacuum the same area. For example, if a typical dust collector included an about 114.3 cm (48 inches) by 15.24 cm (6 inches) opening, there would be 26.76 square meter (288 square feet) of open area. This open area would need a vacuum of about 28,317 LPM (1000 CFM) to collect the dust at 151.8 meters per minute (500 feet per minute) capture velocity. However, with the collection system 10 using the same 114.3 cm by 15.24 cm opening, the open area would be closer to 30.97 square cm (4.8 square inch) (see FIGS. 25-26), for example. This reduced open area would only need about 7.56 LPM (16 CFM) compared to 28,317 LPM (1000 CFM) of the typical dust collector. The vacuum flow required is higher for the collection system 10, but the reduction in LPM/CFM is an advantage compared to typical dust collection systems.

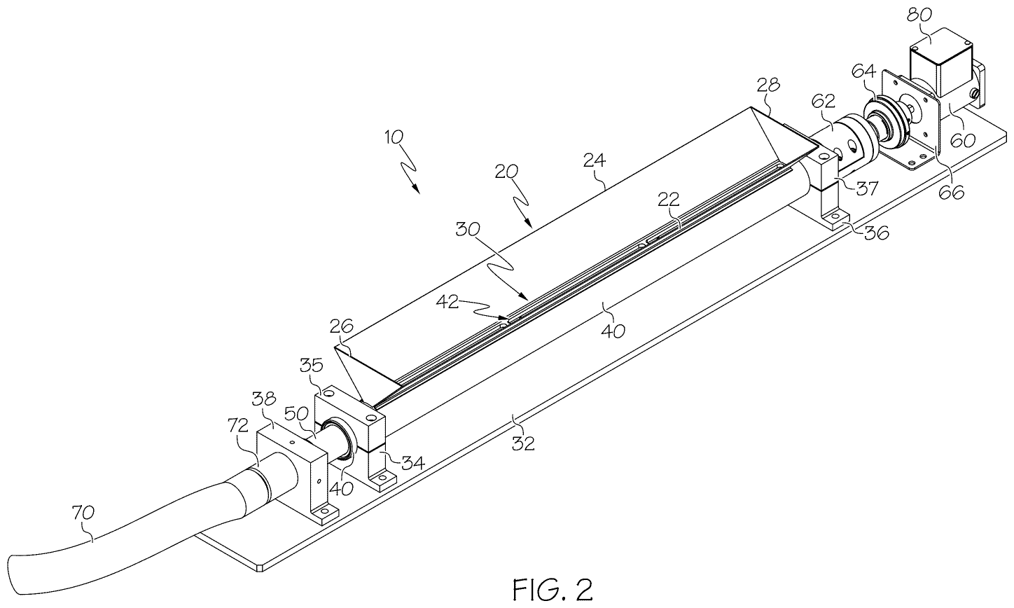

Referring now to FIG. 2, the collection system 10 is depicted fully assembled. In FIG. 2, the hose 70 is shown mounted over the second end of the inlet 72, and the rotating tube 50 is protruding from the first opening 41 of the non-rotating tube 40. It should be noted that the inlet 72 and the hose 70 do not rotate; only the rotating tube 50 rotates during operation.

Referring now to FIG. 3, the inner rotating tube 50 is shown mounted inside the inner diameter of the first side of the inlet 72. The plurality of openings 42 of the non-rotating tube 40 are shown below the opening 30 of the chute 20.

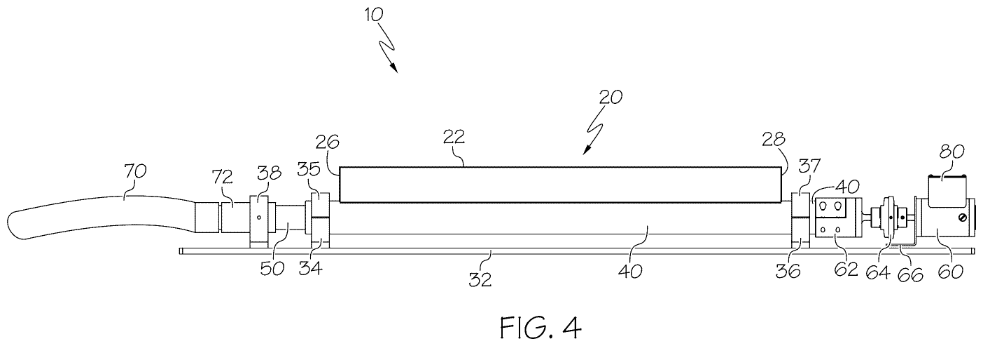

The outer non-rotating tube 40 is depicted protruding from the first bottom support 34 and the first top support 35, as well as the second bottom support 36 and the second top support 37 in FIG. 4. Similar to FIG. 3, the left side (in this view) of the rotating tube 50 is mounted inside the inner diameter of the first side of the inlet 72, whereas the right side (in this view) of the rotating tube 50 is positioned in mechanical communication with the coupler 62. The chute 20 is mounted to the top (in this view) of the non-rotating tube 40, although the chute could be positioned in other positions, if desired by the system designer. For example, the chute 20 might be perpendicular to the non-rotating tube 40, or there could be a plurality of chutes at various angles to the non-rotating tube, as another example.

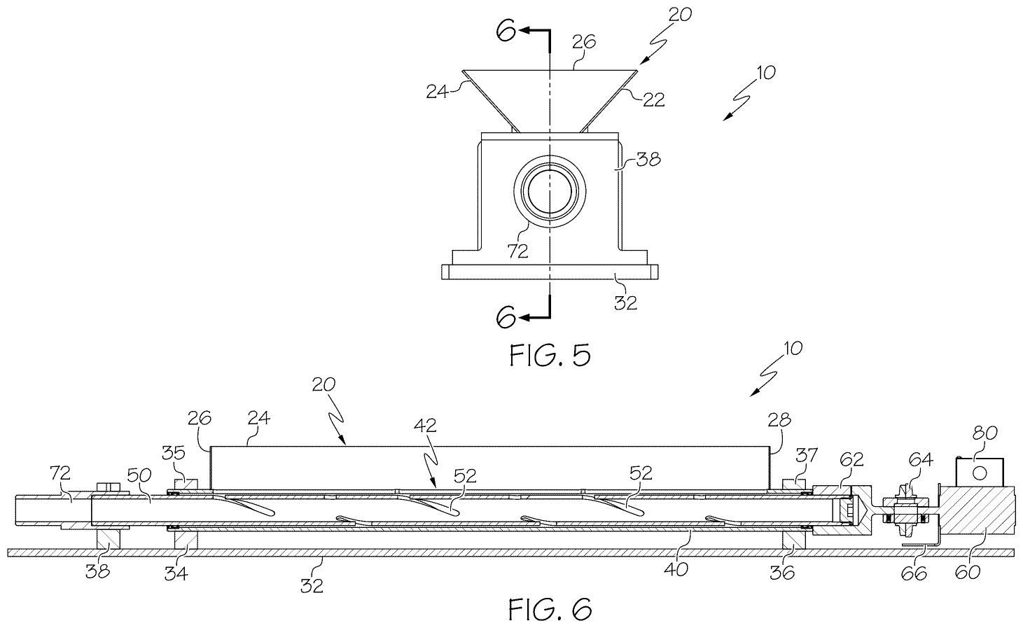

FIG. 5 depicts a side view of the collection system 10, on the inlet 72 side.

Referring now to FIG. 6, the inner rotating tube 50 is fully depicted inside the collection system 10. The rotating tube 50 travels between the inlet 72 and the coupler 62 (i.e., the rotating tube 50 is longer than the non-rotating tube 40), such that when the motor 60 is engaged, the coupler 62 rotates only the rotating tube 50. The torque limiter 64 ensure the motor 60 does not exceed a pre-set rotation speed. The plurality of spaced-apart openings 52 are depicted as several slanted slots on the rotating tube 50 in this embodiment.

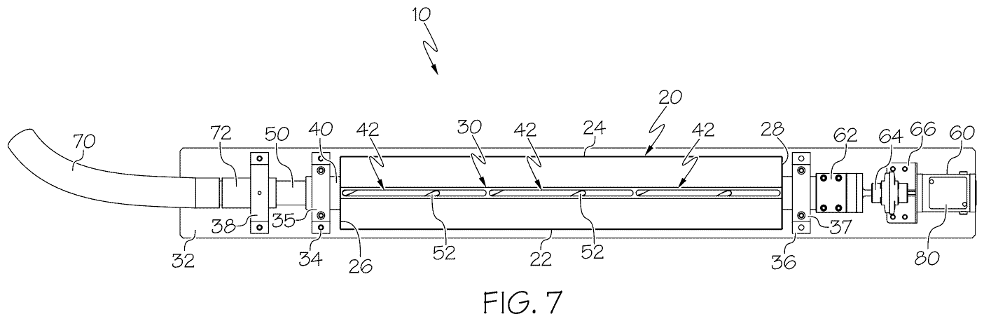

Referring now to FIG. 7, the chute 20 exhibits the opening 30, directly above the plurality of openings 42, and underneath both is the rotating shaft 50 with its plurality of spaced-apart openings 52. In FIGS. 7-14, the operation of the collection system 10 is depicted, illustrating the rotation of the plurality of spaced-apart openings 52. FIG. 7 is an “initial position” of the plurality of spaced-apart openings 52, but it should be noted that during operation, the initial position could be any of the positions illustrated in FIGS. 7-14.

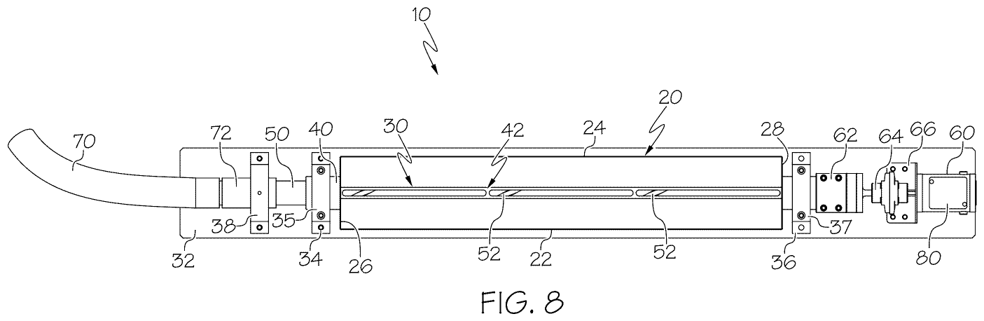

Referring now to FIG. 8, the motor 60 has actuated and begun rotating the inner rotating shaft 50, and the plurality of spaced-apart openings 52 has rotated from their initial position depicted in FIG. 7.

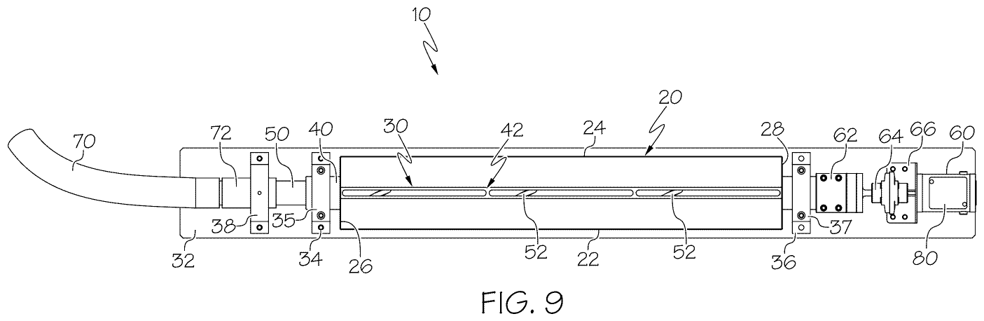

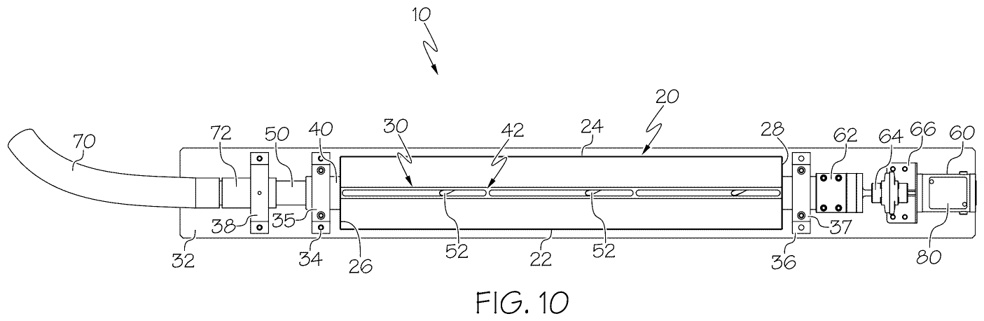

FIG. 9 depicts a further rotation of the plurality of spaced-apart openings 52, and FIG. 10 illustrates a continued rotation of the rotating tube 50.

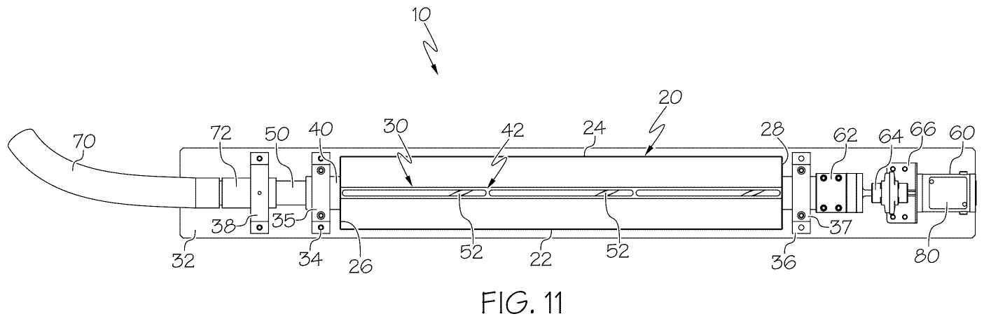

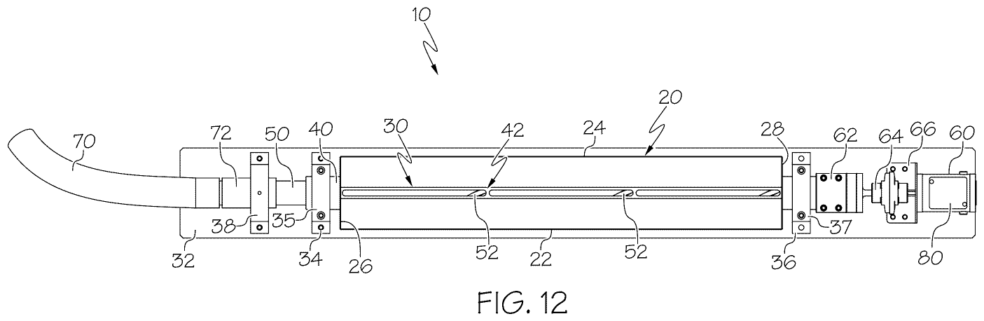

FIG. 11 shows the plurality of spaced-apart openings 52 in a further rotated position, as the motor 60 continues to rotate the inner rotating tube 50, and FIG. 12 depicts another rotated position of the plurality of spaced-apart openings 52.

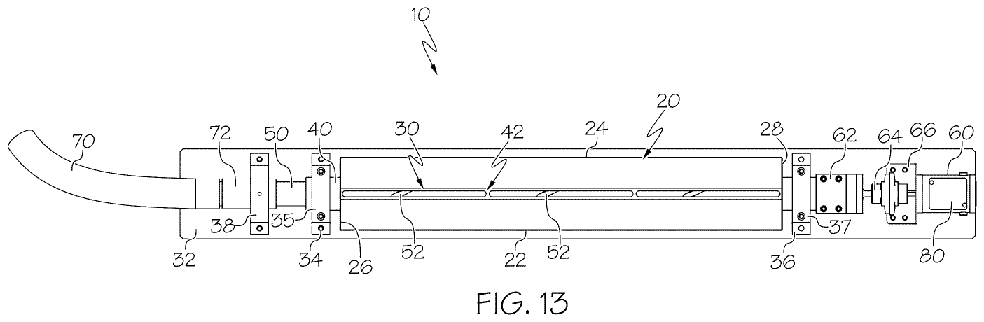

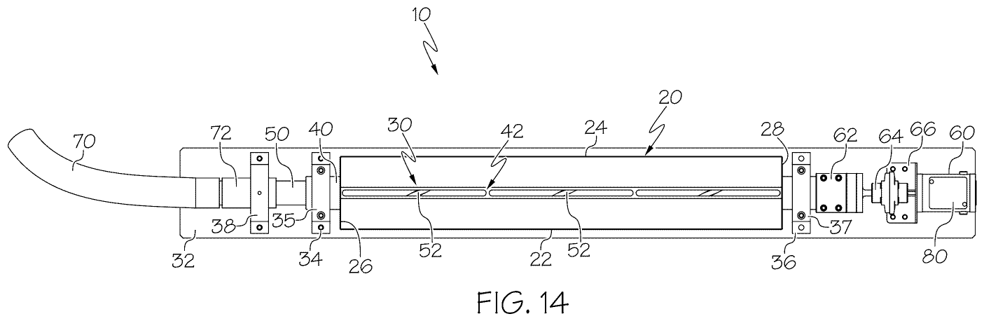

FIG. 13 illustrated yet another rotated position of the plurality of spaced-apart openings 52, and FIG. 14 depicts a final rotated position before the rotating tube 50 returns to its initial position depicted in FIG. 7.

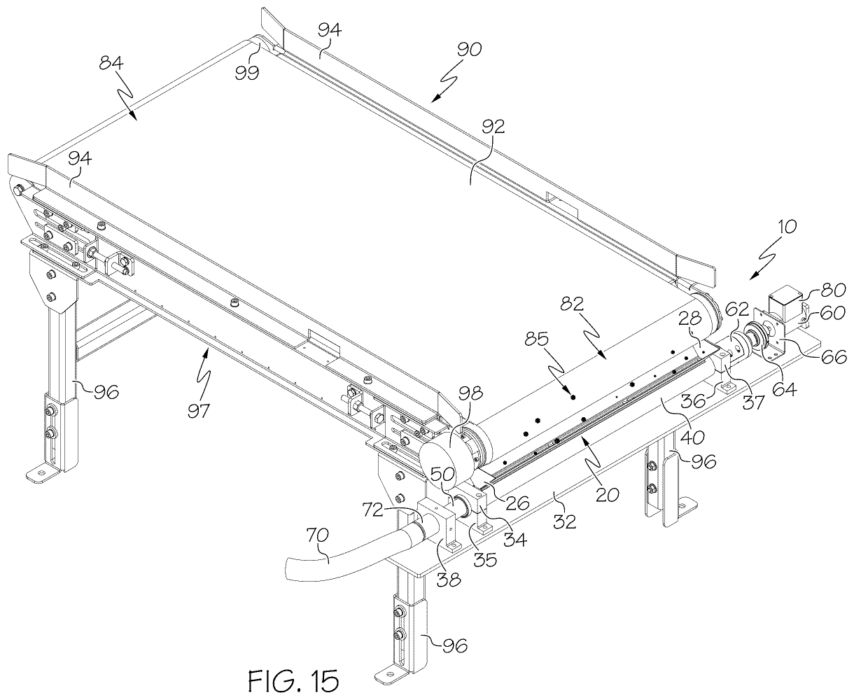

Referring now to FIG. 15, the collection system 10 is depicted mounted onto a conveyor belt sub-assembly 90 (or “conveyor belt S/A”). The conveyor belt S/A 90 includes a belt 90 and a plurality of rails 94 for items to travel on towards the collection system 10. The conveyor belt S/A 90 is supported by a plurality of supports 96 and a conveyor frame 97. The belt 90 is wrapped around both a head pulley 98 and a tail pulley 99, and when both pulleys 98 and 99 are turned on they rotate in sync, thereby moving the belt 90. A feed end 84 is proximal to the tail pulley 99, and a discharge end 82 is proximal to the head pulley 98.

During typical operations, the conveyor belt S/A 90 may consist of several interconnected conveyor belt S/As, and the belt 90 of each conveyor belt S/A carries items toward a destination. The belt 90 gets dirty and may amass particulates 85, such as dust or waste. By positioning the collection system 10 proximal to the discharge end 82, these particulates 85 naturally travel towards the discharge end and would typically fall onto the workspace floor. Instead, as depicted in FIG. 15, these particulates 85 fall, or enter, into the chute 20 and the opening 30, then into the plurality of openings 42. In order to not overwhelm the vacuum system 614 with particulates (see FIG. 21), the plurality of spaced-apart openings 52 are rotated when the collection system 10 is actuated.

This rotation will also help break apart any particulates 85 that may be too large to typically fit in any of the openings of the collection system 10. For example, if a larger particle of waste gets stuck in one of the plurality of spaced-apart openings 52, as that opening rotates the clogged waste particle will slide along one of the plurality of openings 42, due to the slanted orientation of the spaced-apart openings. This sliding action will help to break up the clogged waste particle and allow it to drop into the rotating tube 50.

When actuated, the vacuum system 614 (see FIG. 21) will provide a constant suction of air in the rotating tube 50, through the inlet 72, and out of the hose 70. The hose 70 can be connected to a portable vacuum, for example, or a central vacuum system, or any other suitable system that can provide both suction and waste storage. The constant rotation of the rotating tube 50 along with the air suction provided by the vacuum system 614 means that the collection system 10 will remain relatively clean during operation, as the particulates 85 are continuously vacuumed away and into waste storage.

### Second Embodiment

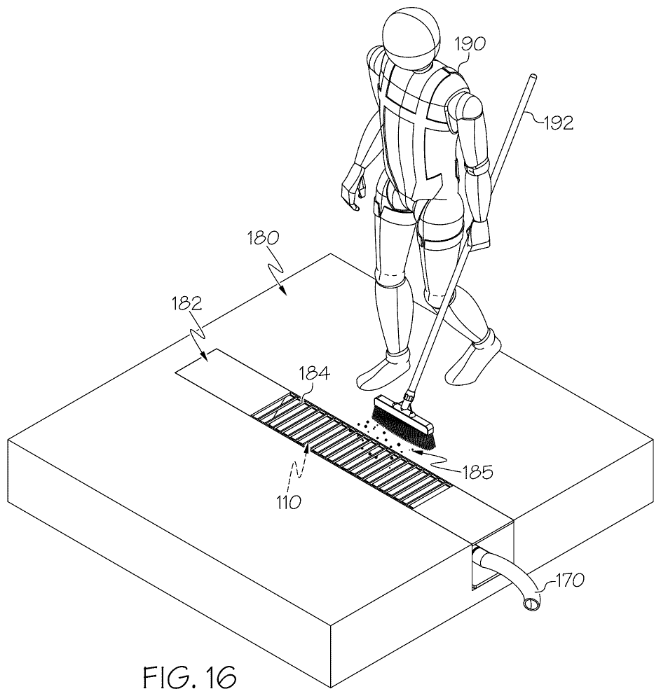

Referring now to FIG. 16, a first alternative embodiment collection system is generally designated by the reference numeral 110. The first alternative embodiment collection system 110 is positioned within a cavity of a worksite floor 180. A removable floor section 182 and a grate 184 are placed above the collection system 110, to protect the collection system from human workers or work vehicles (such as a forklift, for example). The floor cavity can be in communication with the central vacuum system 614 (see FIG. 21), and a vacuum hose 170 can be configured to connect with this central vacuum system.

A human user 190 can use a broom, or a sweeper, 192 to sweep particulates 185 (such as dust or waste) into the grate 184. Alternatively, an auto-sweep machine could be used to sweep particulates 185 into the grate 184. The grate 184 is configured to cover only a chute 120, ensuring that any particulates 185 swept into the grate will fall directly into the collection system 110.

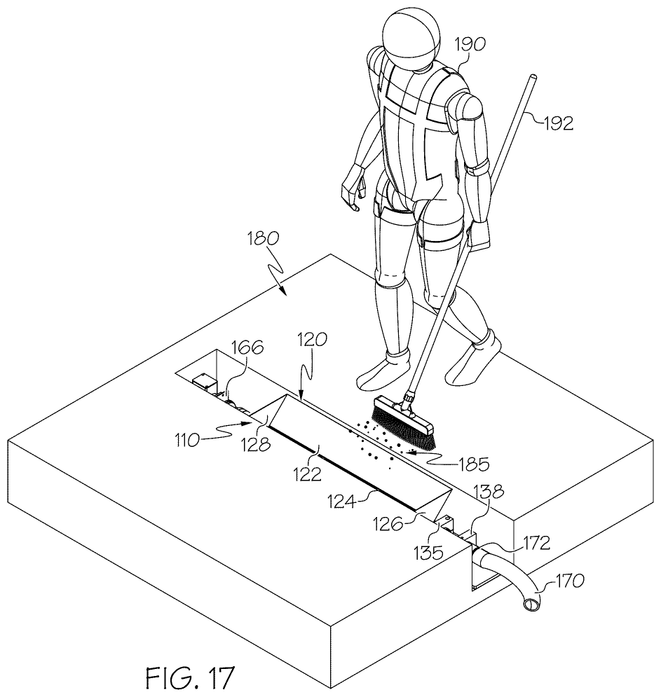

Referring now to FIG. 17, the floor section 180 and the grate 184 are not depicted in this view to better show the collection system 110. The collection system 110 includes a vacuum inlet 172, a support 138 a top support 135, a motor mount 166, a motor (not shown in this view), and the chute 120. The vacuum inlet 172 and the vacuum hose 170 are in pneumatic communication, and are supported by the support 138. The chute 120 includes a first ramp 122, a second ramp 124, a first side 126, and a second side 128. Although not shown in FIGS. 16 and 17, the collection system 110 is configured with the same mechanical structure as the first embodiment collection system 10. The collection system 110 includes an outer non-rotating tube and an inner rotating tube, and when the collection system 110 is actuated, the particulates 185 collected by the chute 120 and the inner rotating tube are removed via the external vacuum system 614 (see FIG. 21), which is in pneumatic communication with the vacuum hose 170.

### Third Embodiment

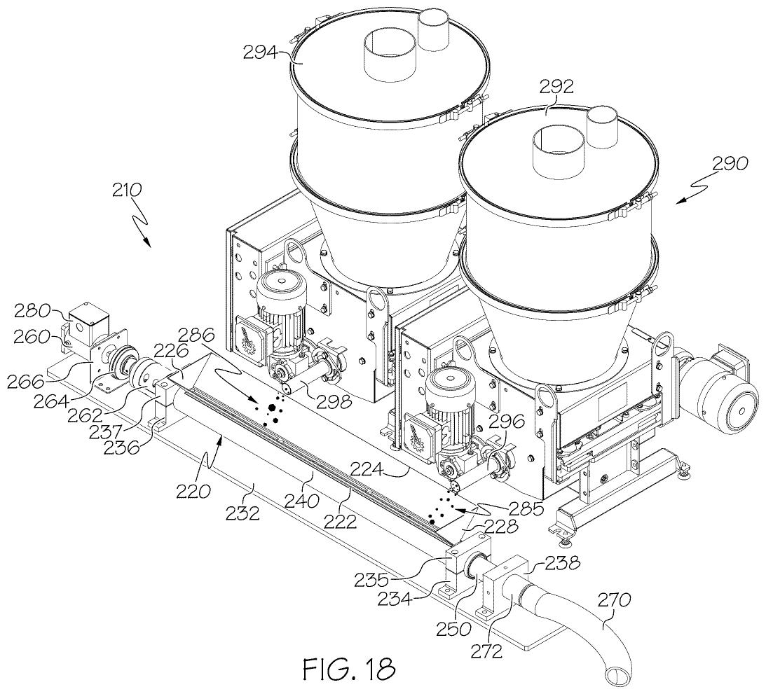

Referring now to FIG. 18, a second alternative embodiment collection system is generally designated by the reference numeral 210. The second alternative embodiment collection system 210 includes a base 232 (also sometimes referred to herein as a “base plate”) with a first bottom support 234 and a second bottom support 236 separately mounted to the base 232. An outer stationary tube 240 (also sometimes referred to herein as a “non-rotating tube”) is positioned on the first bottom support 234 and the second bottom support 236, and secured to the base 232 by a first top support 235 and a second top support 237. The first top support 235 mounts directly onto the first bottom support 234, and the second top support 237 mounts directly onto the second bottom support 236.

The outer non-rotating tube 240 exhibits a plurality of openings (not shown in FIG. 18): a first opening proximal to the first bottom support 234, a second opening proximal to the second bottom support 236, and a plurality of openings that are positioned on one side portion of the non-rotating tube 240 that are proximal to each other along the length of the non-rotating tube. A chute 220, exhibiting an opening (not shown in FIG. 18), is mounted proximal to the non-rotating tube 240 such that the chute opening is directly above the non-rotating tube's plurality of openings. The chute 220 includes a first ramp 222, a second opposite ramp 224, a first side 226, and a second opposite side 228.

An inner rotating tube 250 (also sometimes referred to herein as a “rotating tube”) having a plurality of spaced-apart openings (not shown in FIG. 18) along the tube's 250 cylindrical wall, or sleeve, is positioned inside the outer non-rotating tube 240. The rotating tube 250 exhibits a third opening (not shown in FIG. 18) proximal to the first bottom support 234 and a fourth opening (not shown in FIG. 18) proximal to the second bottom support 236.

A motor mount 266, exhibiting an opening (not shown in FIG. 18), is mounted to the base 232 proximal to the second bottom support 236 and the second top support 237. A motor 260 is mounted on one side of the motor mount 266, and a torque limiter 264 along with a coupler 262 are both mounted on a second, opposite side of the motor mount 266. The motor 260 is in mechanical communication with the torque limiter 264 through the motor mount opening, and the torque limiter 264 is in mechanical communication with the coupler 262. The motor 260 includes a port 280 for an external power source, and this port 280 can be a receptacle, as one example, or an integrated power cable, as another example. The rotating tube 250 is in mechanical communication with the coupler 262, and during operation, the motor 260 rotates the inner rotating tube 250.

A support 238, exhibiting a through-hole (not shown in FIG. 18), is mounted to the base 232 proximal to the first bottom support 234 and the first top support 235. An inlet 272 is positioned in the support through-hole, and the rotating tube's third opening fits inside the inner diameter of a first end of the inlet. A hose 270 fits over a second, opposite side of the inlet 272. The non-rotating tube 240, the rotating tube 250, the inlet 272, and the hose 270 are all in pneumatic communication with each other. The hose 270 is attached to the vacuum system 614 (see FIG. 21), such as a portable vacuum or a central vacuum system.

In FIG. 18, the collection system 210 is depicted positioned with a first mixer sub-assembly 290 (also sometimes referred to herein as a “first mixer S/A”). The first mixer S/A 290 includes a first mixer chamber 292 with a first dispenser 296, and a second, separate mixer chamber 294 with a second dispenser 298. The first mixer chamber 292 contains a first material composition 285, that could comprise a single material, or a plurality of materials, and the second mixer chamber 294 contains a second material composition 286. This second material composition could comprise a different material than the first material composition, or it could comprise another quantity of the same material.

Once the first material composition 285 and the second material composition 286 are ready to dispense, the first dispenser 296 and the second dispenser 298 are opened. The collection system 210 is also actuated at this point. As the first and second material compositions 285, 286 exit the first and second mixer chambers 292, 294, both material compositions are deposited into the chute 220. The material compositions then drop into the rotating tube 250 and are then mixed together as the rotating tube rotates. The vacuum system 614 (see FIG. 21) then suctions (i.e., removes) this new mixed composition out of the rotating tube 250 and into a collected material container 616 (see FIG. 21), such as a storage bin, or other movable container.

### Fourth Embodiment

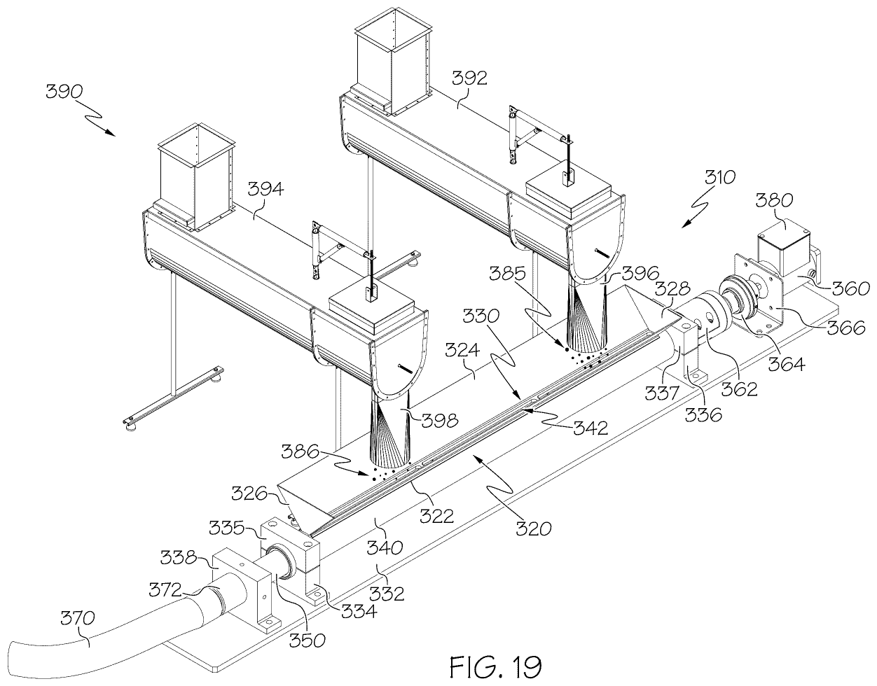

Referring now to FIG. 19, a third alternative embodiment collection system is generally designated by the reference numeral 310. The third alternative embodiment collection system 310 includes a base 332 (also sometimes referred to herein as a “base plate”) with a first bottom support 334 and a second bottom support 336 separately mounted to the base 332. An outer stationary tube 340 (also sometimes referred to herein as a “non-rotating tube”) is positioned on the first bottom support 334 and the second bottom support 336, and secured to the base 332 by a first top support 335 and a second top support 337. The first top support 335 mounts directly onto the first bottom support 334, and the second top support 337 mounts directly onto the second bottom support 336.

The outer non-rotating tube 340 exhibits a longitudinal plurality of openings 342 that are positioned on one side portion of the non-rotating tube 340, and are proximal to each other along the length of the non-rotating tube. A chute 320, exhibiting an opening 330, is mounted proximal to the non-rotating tube 340 such that the chute opening is directly above the non-rotating tube's plurality of openings. The chute 320 includes a first ramp 322, a second opposite ramp 324, a first side 326, and a second opposite side 328. An inner rotating tube 350 (also sometimes referred to herein as a “rotating tube”) having a plurality of spaced-apart openings (not shown in FIG. 19), is positioned inside the outer non-rotating tube 340.

A motor mount 366, exhibiting an opening (not shown in FIG. 19), is mounted to the base 332 proximal to the second bottom support 336 and the second top support 337. A motor 360 is mounted on one side of the motor mount 366, and a torque limiter 364, along with a coupler 362, are both mounted on a second, opposite side of the motor mount 366. The motor 360 is in mechanical communication with the torque limiter 364 through the motor mount opening, and the torque limiter 364 is in mechanical communication with the coupler 362. The motor 360 includes a port 380 for an external power source, and this port 380 can be a receptacle, as one example, or an integrated power cable, as another example. The rotating tube 350 is in mechanical communication with the coupler 362, and during operation, the motor 360 rotates the inner rotating tube 350.

A support 338, exhibiting a through-hole (not shown in FIG. 19), is mounted to the base 332 proximal to the first bottom support 334 and the first top support 335. An inlet 372 is positioned in the support through-hole, and one end of the rotating tube fits inside the inner diameter of a first end of the inlet. A hose 370 fits over a second, opposite side of the inlet 372. The non-rotating tube 340, the rotating tube 350, the inlet 372, and the hose 370 are all in pneumatic communication with each other. The hose 370 is attached to the vacuum system 614 (see FIG. 21), such as a portable vacuum or a central vacuum system.

In FIG. 19, the collection system 310 is depicted positioned with a second mixer sub-assembly 390 (also sometimes referred to herein as a “second mixer S/A”). The second mixer S/A 390 includes a third mixer chamber 392 with a third dispenser 396, and a fourth, separate mixer chamber 394 with a fourth dispenser 398. The third mixer chamber 392 contains a third material composition 385, that could comprise a single material, or a plurality of materials, and the fourth mixer chamber 394 contains a fourth material composition 386. This fourth material composition could comprise a different material than the third material composition, or it could comprise another quantity of the same material.

Once the third material composition and the fourth material composition are ready to dispense, the third dispenser 396 and the fourth dispenser 398 are opened. The collection system 310 is also actuated at this point. As the third and fourth material compositions 385, 386 exit the third and fourth mixer chambers 392, 394, both material compositions are deposited into the chute 320. The material compositions then drop into the rotating tube 350 and are then mixed together as the rotating tube rotates. The vacuum system 614 (see FIG. 21) then suctions (i.e., removes) this new mixed composition out of the rotating tube 350 and into a collected material container 616 (see FIG. 21), such as a storage bin, or other movable container.

### Fifth and Sixth Embodiments

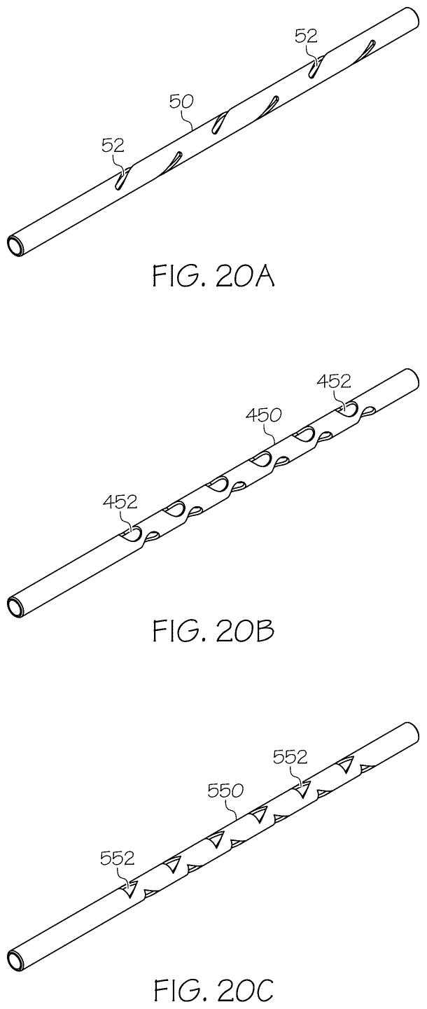

Referring now to FIG. 20A, the first embodiment rotating tube 50 is depicted exhibiting a plurality of spaced-apart openings 52 along the tube's 50 cylindrical wall, or sleeve. In the first embodiment, the spaced-apart openings 52 are illustrated as elongated slants. However, other types of spaced-apart openings could be used.

For example, a fourth alternative embodiment rotating tube depicted on FIG. 20B is generally designated by the reference numeral 450. This rotating tube 450 exhibits a plurality of spaced-apart through-openings 452 along the tube's 450 cylindrical wall, or sleeve, that are illustrated as circular-shaped through-holes. As another example, a fifth alternative embodiment rotating tube depicted on FIG. 20C is generally designated by the reference numeral 550. The fifth alternative embodiment rotating tube 550 exhibits a plurality of spaced-apart through-openings 552 along the tube's 550 cylindrical wall, or sleeve, that are illustrated as triangular-shaped through-holes. Many other such spaced-apart openings could be used, the design of which depends on the desires of the designer.

Referring now to FIG. 21, a conveyor belt 690 can be used to transport items, and doing so generates particulates such as dust or waste material. In some systems, an optional scraper 612 may be used to wipe (i.e., “scrape”) the accumulated particulates off the conveyor belt 690. Next, a collection system 610 is positioned proximal to the conveyor belt 690 and, if included, the scraper 612. Particulates from the conveyor belt 690, and the optional scraper 612, are directed into the collection system 610.

The vacuum system 614 (such as a central vacuum system) is pneumatically connected to the collection system 610. The vacuum system 614 removes collected particulates from the collection system 610 using a suction force. Lastly, the vacuum system 614 deposits the collected particulates into a collected material container 616. This container 616 can be a central waste bin, or a movable cart, or even a sturdy bag.

It should be noted that FIG. 21 depicts only one use for the collection system 610. As described above, the collection system 610 can be used for a variety of manufacturing techniques, such as collecting waste particulates or collecting chemical or edible materials. Instead of showing the conveyor belt, FIG. 21 could instead show one of the mixers illustrated on FIG. 18 or 19.

### Seventh Embodiment

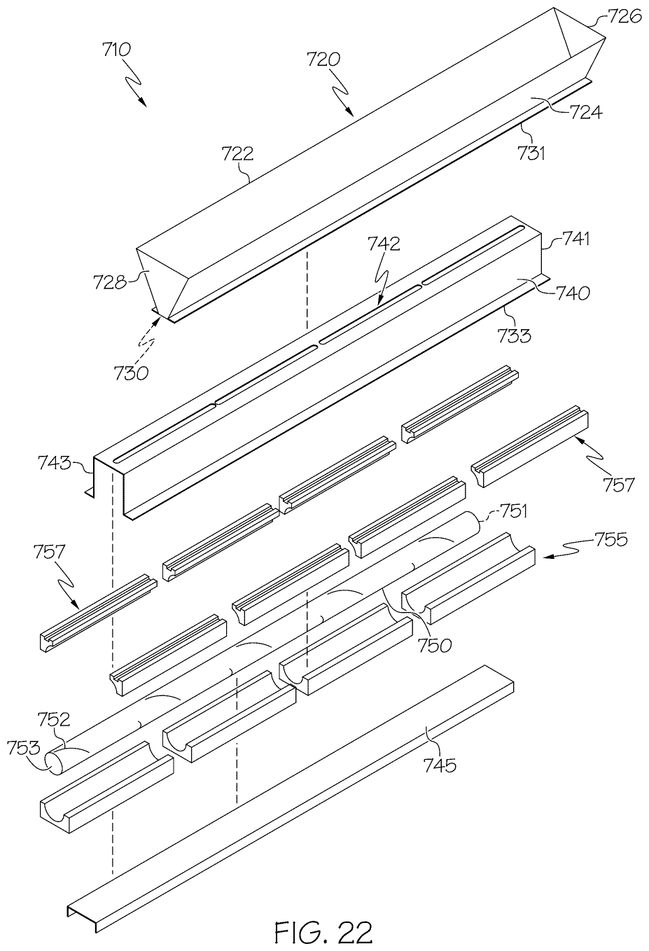

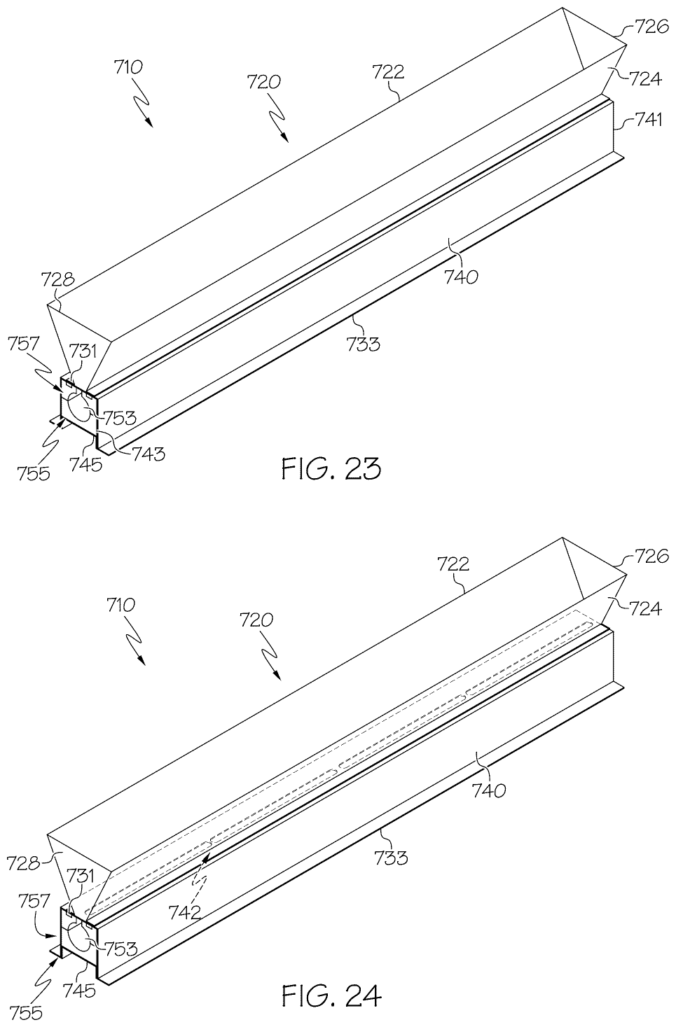

Referring now to FIG. 22, a sixth alternative embodiment collection system is generally designated by the reference numeral 710. An outer stationary enclosure 740 exhibits a plurality of longitudinal openings 742, a first opening 741, and a second, opposite opening 743. The stationary enclosure 740 is somewhat U-shaped, except each “side” of the U-shape is straight, with two 90-degree bends forming the “U.” The plurality of longitudinal openings 742 are positioned on the top portion of the stationary enclosure 740, and are proximal to each other along the longitudinal length of stationary enclosure. The stationary enclosure 740 has flange portions 733 on each vertical “side” of its U-shape.

A chute 720, exhibiting an opening 730, is mounted proximal to the stationary enclosure 740 such that the opening 730 is directly above the plurality of openings 742. The chute 720 includes a first ramp 722, a second opposite ramp 724, a first side 726, and a second opposite side 728. The chute 720 includes a flange portion 731 on each side of the opening 730.

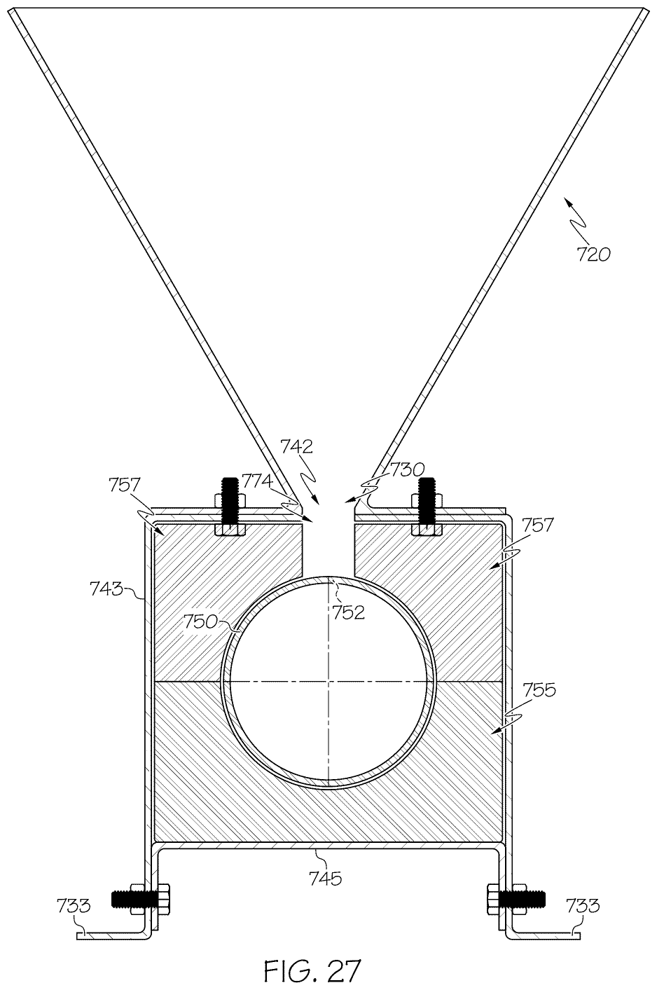

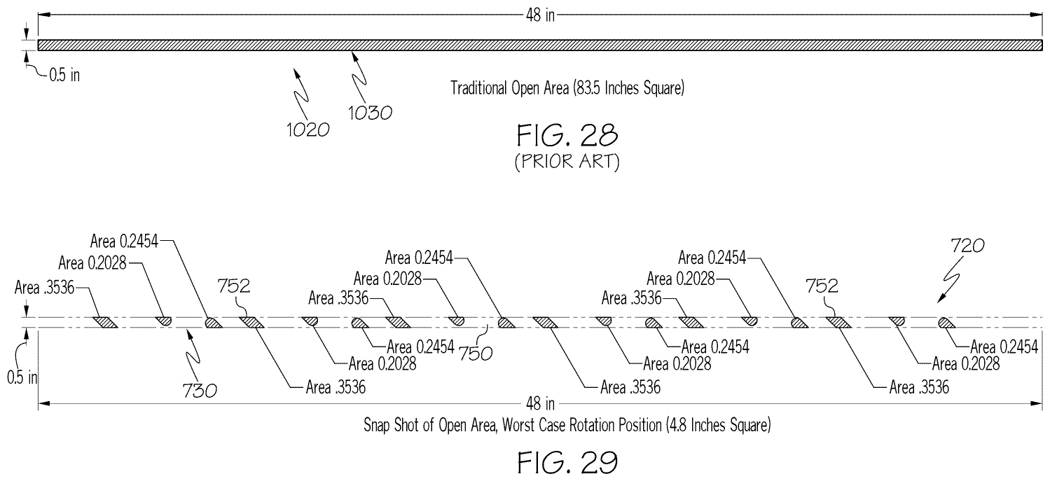

A rotatable housing 750, having a plurality of spaced-apart through-openings 752 along the rotatable housing's 750 cylindrical wall, or sleeve, is positioned inside the outer stationary enclosure 740. The rotatable housing 750 could be designed as any non-orthogonal shape, depending on the designer's desires, as long as the desired shape is rotatable (see FIGS. 27-28, for example). The rotatable housing 750 exhibits a first end 751 and a fourth, second end 753. Although not depicted in this embodiment, a motor is in mechanical communication with the rotatable housing 750, similar to the previous embodiments discussed above.

The rotatable housing 750 is positioned on a plurality of cradles 755 that support the rotatable housing. These cradles 755 are mounted to a base portion 745, and this base portion 745 is secured to the stationary enclosure 740. A plurality of upper fillers 757 are positioned on top of the plurality of lower cradles 755, and provide an essentially air-tight configuration with the rotatable housing 750 and the stationary enclosure 740. The plurality of fillers 757 essentially confine the rotatable housing 750 against the plurality of cradles 755 inside the stationary enclosure 740. The plurality of fillers 757 exhibit a gap 774 (see FIG. 27) that is proximal to the bottom opening 730. Of course, the plurality of cradles 755 could instead be a single-piece cradle, depending on the desires of the designer, and the plurality of fillers 757 could instead be two single pieces (or one piece with openings to simulate the gap 774).

Referring now to FIG. 24, the sixth alternative embodiment collection system 710 is illustrated assembled together. The plurality of cradles 757, the rotatable housing 750, and the plurality of upper fillers 755 are depicted filling up the open space between the base portion 745 and the stationary enclosure 740.

In FIG. 24, the longitudinal plurality of openings 742 are shown. When particulates enter the chute 720, the particulates drop through the opening 730 and fall through the longitudinal plurality of openings 742, through the plurality of spaced-apart openings 752, and are then sucked out of the collection system 710 by an external vacuum system.

Referring now to FIG. 25, some dimensions are shown as examples of how to construct the sixth alternative embodiment particulate collection system 710. For example, the top of the chute 720 exhibits an opening of about 15.24 cm, and then narrows down to about 1.27 cm at the opening 730. The stationary enclosure exhibits a width of about 8.89 cm.

Referring now to FIG. 26, more dimensions are shown as examples of how to construct the sixth alternative embodiment particulate collection system 710. For example, the length of the chute 720 is about 114.3 cm, whereas the rotatable housing diameter is about 5.08 cm. In FIG. 26, a first support 734 and a second, opposite support 736 are used to secure the rotatable housing 750. A vacuum inlet adaptor 772 is mounted at the first end 751, and the rotatable housing 750 is freely rotatable within the vacuum inlet. A vacuum hose 770 is mounted on the opposite end of the inlet 772, and the hose 770 is in pneumatic communication with an external vacuum system (not shown in FIG. 26). Note that, although not shown in FIG. 26, a motor would be positioned proximal to the second end 753 and be in mechanical communication with the rotatable housing 750.

Referring now to FIG. 27, the plurality of fillers 757, the rotatable housing 750, and the plurality of cradles 745 are shown positioned inside the stationary enclosure 743. In FIG. 27, the gap 774 between the plurality of fillers 757 is illustrated. When the external vacuum system 614 is engaged, the vacuum flow pulls air from the bottom opening 730 of the chute 720, through the longitudinal plurality of openings 742, through the gap 774, and then through the plurality of spaced-apart openings 752. This air is then removed from inside the rotatable housing 750, through the inlet adaptor 772 and out through the vacuum hose 770. At the same time, any particulates that drop into the chute 720 follow the same path as the vacuum air flow.

The gap 774 is intentionally positioned directly below the chute's bottom opening 730 and the plurality of longitudinal openings 742. This ensures that the vacuum air flow, and any collected particulates, only flow through that small gap portion of the plurality of spaced-apart openings 752. As described in further detail below, and in FIG. 29, the fillers 757 and the cradles 755 essentially reduce the vacuum flow needed to collect particulates over this gap area, verses a traditional system.

### Prior Art

Referring now to FIG. 28, a bottom opening 1030 of a prior art chute 1020 is depicted. The prior art chute 1020 has a length of about 121.92 cm (48 inches) with a width of about 15.24 cm (6 inches) at the top that tapers down to about 1.27 cm (0.5 inches) at the bottom, which provides an open area of about 538.7 cm² (83.5 square inches). The vacuum flow needed to provide a constant suction to this large open area is about 2,364.5 LPM (83.5 CFM), at about 2.5 meters per second (500 feet per minute). However, the present invention limits the quantity of volume capacity of vacuum flow needed over the same size opening.

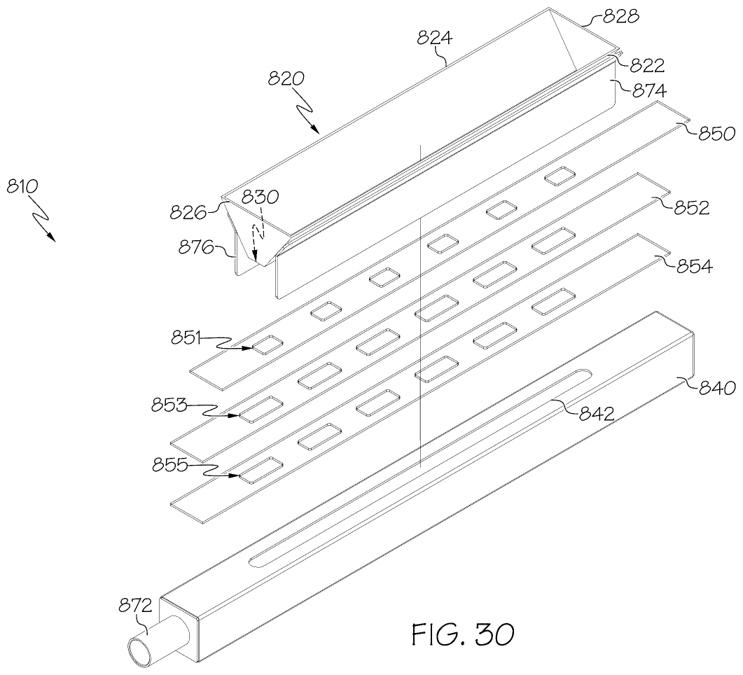

Referring now to FIG. 29, the bottom opening 730 of the present invention chute 720 is depicted. The chute 720 in FIG. 29 exhibits the same dimensions as the prior art chute 1020 illustrated in FIG. 28, as an example. However, the plurality of openings 752 on the rotatable housing 750 are shown beneath the opening 730 and, along with the fillers 757 and the cradles 755, greatly reduces the open area for collected particulates to travel out of the bottom of the chute 720. The plurality of openings 752 exhibit one of three open areas in FIG. 30: about 2.28 cm² (0.3536 square inches); about 1.31 cm² (0.2028 square inches); or about 1.58 cm² (0.2454 square inches). The plurality of openings 752 provide an open area of about 31 cm² (4.8 square inches)-which is a drastic reduction in open area when compared to the prior art depicted in FIG. 28. For example, using the same velocity as above (i.e., about 2.5 meters per second (500 feet per minute)), the vacuum flow needed to provide a constant suction to this large open area is about 481.4 LPM (17 CFM).

During operation, the rotatable housing 750 spins such that the plurality of openings 752 move the same open area constantly over the 121.92 cm (48 inches) bottom opening 730. Of course, the speed at which to rotate the rotatable housing 750 is variable, and will be determined by the materials planned to be collected. The human operator will adjust the motor to achieve the desired rotational speed.

In other words, the at least one through-opening 752 of the hollow rotatable housing 750 includes a plurality of through-openings that are located at various positions along both an elongated length and a cross-sectional wall, or sleeve, of the rotatable housing 750 and, as the rotatable housing is rotated, then at least one of the plurality of through-openings 752 appears at every position along the effective elongated length at one of the rotational positions during each complete rotation of the rotatable housing 750, in which the effective elongated length does not include mounting positions.

### Eighth Embodiment

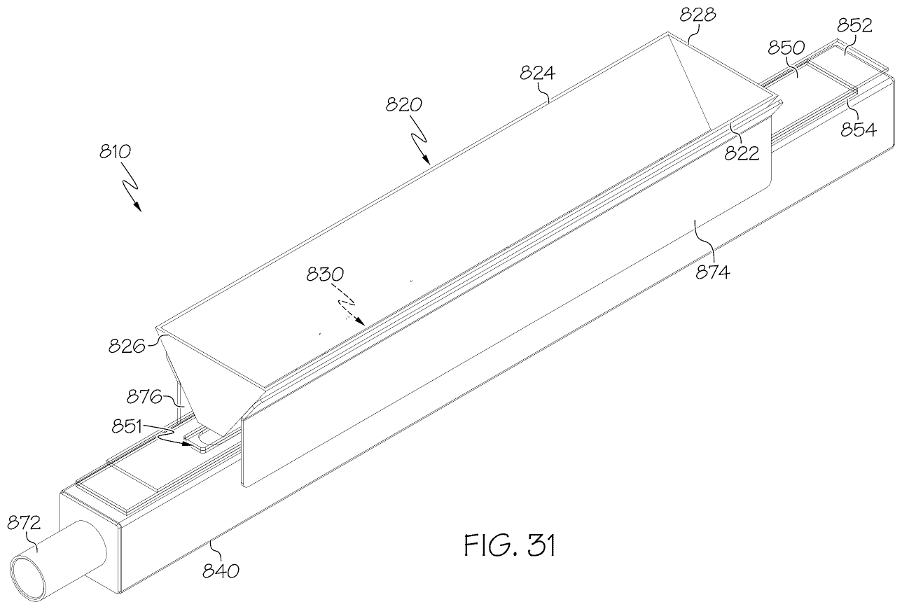

Referring now to FIG. 30, a seventh alternative embodiment particulate collection system is generally designated by the reference numeral 810. The collection system 810 includes a hollow stationary enclosure 840 exhibiting a longitudinal opening 842 and having a vacuum inlet 872, for pneumatic connection with an external vacuum system. The collection system 810 also includes a chute 820 exhibiting a first ramp 822, a second ramp 824, a first side 826, a second side 828, and having an opening 830. The chute 820 has a first mount plate 874 and a second, opposite mount plate 876, and these plates secure the chute 820 to the hollow stationary enclosure 840 (see FIG. 31).

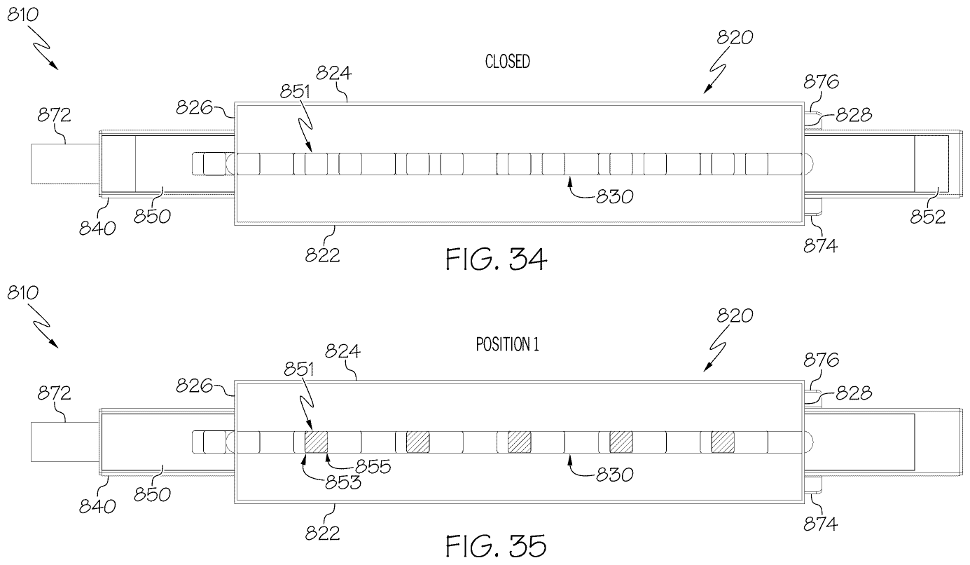

Positioned between the chute lower opening 830 and the longitudinal opening 842 are a first sliding plate 850, a second sliding plate 852, and a third sliding plate 854. The first sliding plate exhibits a first plurality of spaced-apart openings 851, the second sliding plate exhibits a second plurality of openings 853, and the third sliding plate exhibits a third plurality of openings 855. These three sliding plates 850, 852, 854 can individually reciprocate along the longitudinal opening 842, so that the plurality of spaced-apart openings 851, 853, 855 can sift particulates into the hollow stationary enclosure 840. The three sliding plates 850, 852, 854 can also be positioned into a closed or sealed state, such that no particulates can enter the hollow stationary enclosure 840 (see FIG. 34). Each sliding plate 850, 852, 854 can be individually moved by a variety of methods, one example being a linear actuator. Of course, the designer can use whatever method fits best for a particular environment.

Referring now to FIG. 31, the seventh alternative embodiment particulate collection system 810 is depicted fully assembled. Similar to the other collection system embodiments, particulates are dropped into the top of the chute 820, fall through the opening 830, then travel through at least three of the plurality of spaced-apart openings 851, 853, 855 (at least one opening on each sliding plate), then through the longitudinal opening 842, and finally collect inside the hollow stationary housing 842. The particulates are then sucked out through the vacuum inlet 872 when the external vacuum system is actuated.

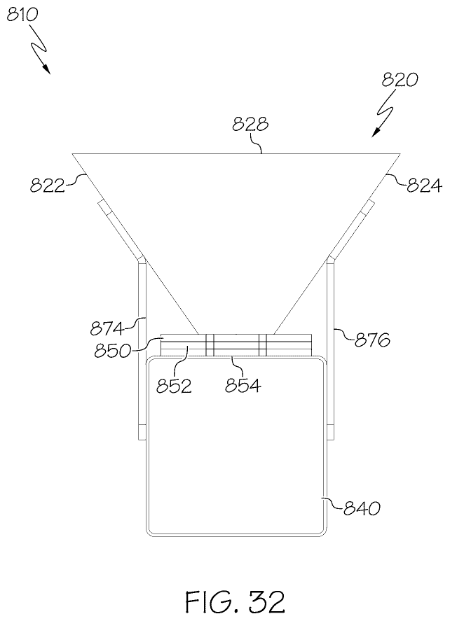

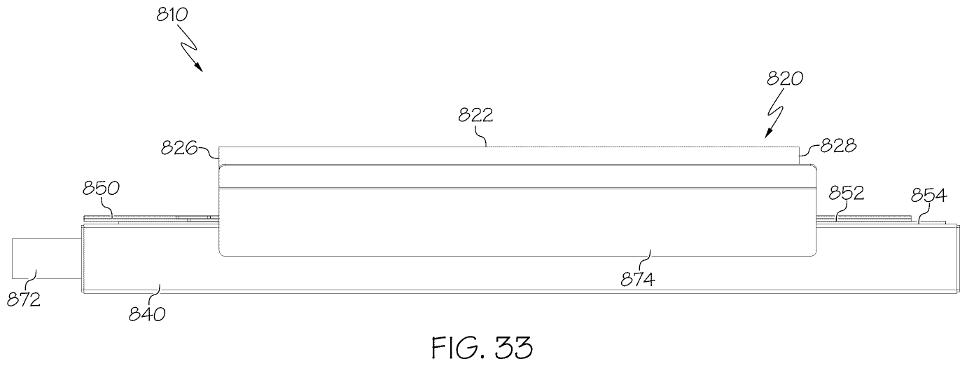

Referring now to FIG. 32, a right elevational view of the seventh alternative embodiment particulate collection system 810 is illustrated. In FIG. 32, the first mount plate 874 and the second mount plate 876 are secured to both the hollow stationary enclosure 840 and the chute 820. In FIG. 33, the chute 820 is shown protruding above the first mount plate 874.

FIGS. 34-37 show a sequence of operation of the seventh alternative embodiment particulate collection system 810, particularly the movement of the sliding plates 850, 852, 854. Beginning with FIG. 34, the system 810 is shown in a closed or sealed position (i.e., particulates cannot fall into the hollow stationary enclosure 840). The sliding plates 850, 852, 854 are positioned such that the plurality of spaced-apart openings 851, 853, 855 do not overlap with each other to create a through-opening between the opening 830 and the longitudinal opening 842.

Next, a “position one” or “first position” is illustrated in FIG. 35. At least one sliding plate 850, 852, 854 moves either left or right (in this view) to create an opening with the plurality of spaced-apart openings 851, 853, 855 (i.e., at least three openings are overlapping each other, one on each sliding plate). This opening is depicted in FIG. 35 by reference numbers 851, 853, 855 all pointing to the same location, and five openings are illustrated in FIG. 35.

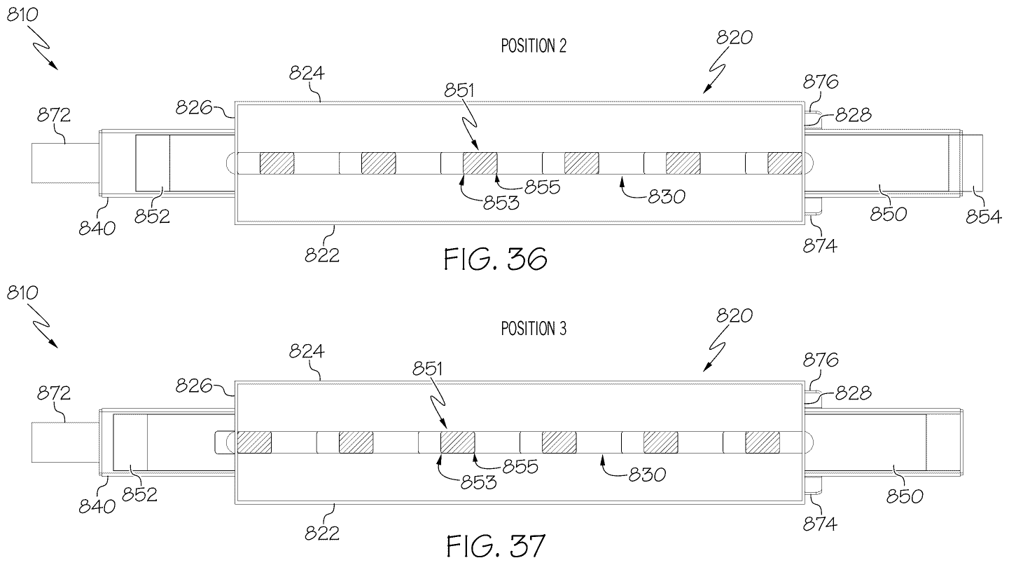

Continuing on to FIG. 36, a “position two” or “second position” is illustrated. At least one sliding plate 850, 852, 854 continues to move either left or right (in this view) to create a wider opening (depicted here by reference numbers 851, 853, 855 pointing to the same location). It should be noted that a plurality of openings are created when all three sliding plates “align”their plurality of openings, and six openings are depicted on FIG. 36.

Lastly, in FIG. 37, a “position three” or “third position” is illustrated. At least one sliding plate 850, 852, 854 has moved further to the left or the right (in this view) to create a different set of openings (six such openings are illustrated on FIG. 37). Again, one such opening is depicted by reference numbers 851, 853, 855 pointing to the same location. During operation, as the sliding plates reciprocate left and right (in this view), openings can be created along the length of the longitudinal opening 842 and the chute lower opening 830 to catch wherever particulates fall. Alternatively, the sliding plates 850, 852, 854 could instead be moved to one of the positions shown in FIGS. 35-37 and then kept stationary.

### Ninth Embodiment

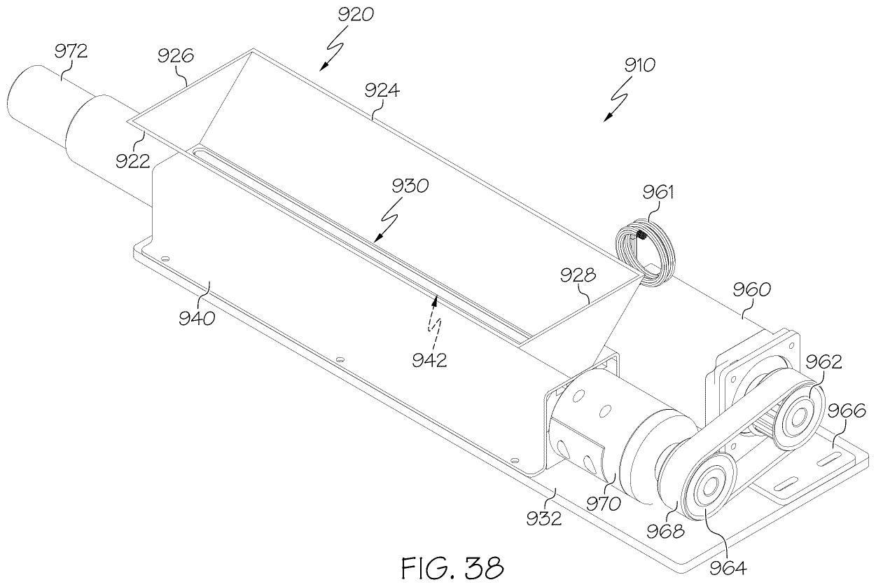

Referring now to FIG. 38, an eighth alternative embodiment particulate collection system is generally designated by the reference numeral 910. The collection system 910 includes a chute 920 exhibiting a first ramp 922, a second ramp 924, a first side 926, a second side 928, and having a lower opening 930. The chute 920 and a hollow stationary enclosure 940 are constructed of a single piece of material (preferably a metal, such as aluminum, for example), and the stationary enclosure 940 exhibits a longitudinal opening 942. The chute opening 930 and the longitudinal opening 942 are the same opening in this eighth alternative embodiment collection system 910.

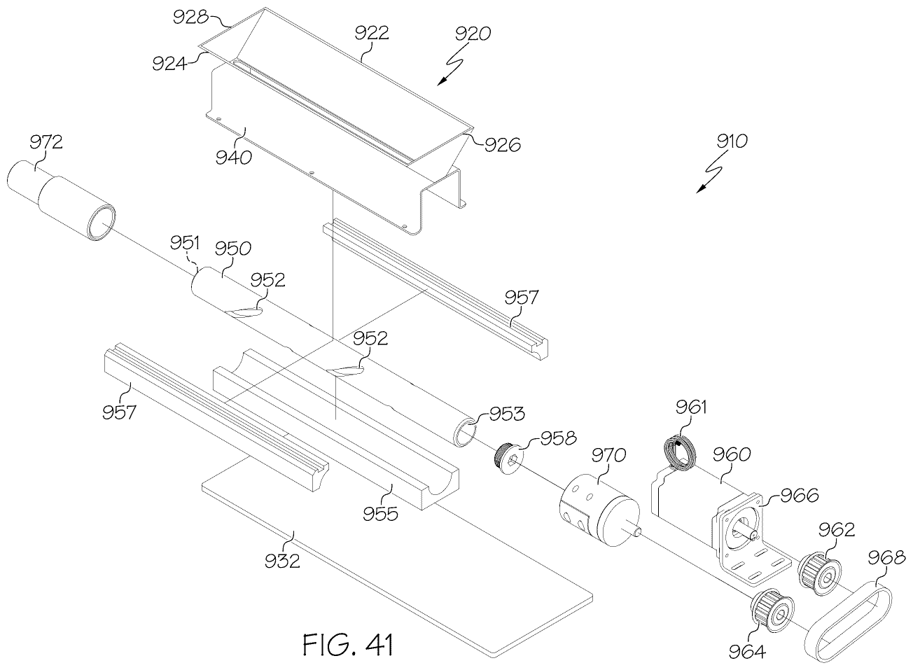

The chute 920 and the hollow stationary enclosure 940 are mounted to an elongated base 932. A motor mount 966 is mounted to the base 932, and a motor 960, including motor wires 961 for connection to a power source, is positioned on the motor mount 966. A hollow rotatable housing 950 (also sometimes referred to herein as an inner rotatable hollow tube or shaft) is positioned inside the hollow stationary enclosure 940, and this inner rotatable tube 950 has a first opening or first end 951, a second opening or second end 953, and a plurality of spaced-apart openings 952. These openings 952 are spaced-apart along a wall of the hollow rotatable housing 950 (see FIG. 41). The inner rotatable tube 950 seats onto a cradle 955, and a plurality of fillers 957 are placed on top of the tube 950, and then the hollow stationary enclosure 940 is placed on top (see FIG. 41). In this manner, the inner rotatable tube 950 cannot displace during operation, yet is still able to rotate.

A seal 958 is placed at the second end 953 of the hollow rotatable housing 950 (see FIG. 41), and a shaft coupler 970 (also sometimes referred to herein as a “coupler”) is positioned proximal to the seal 958. A vacuum inlet 972 (also sometimes referred to herein as a “hose mount”) is placed at the first end 951 of the hollow rotatable housing 950, and an external vacuum system is pneumatically connected to this inlet during operation.

A first pulley 962 is mounted to the motor 960, and a second pulley 964 is mounted to the coupler 970. A belt 968 is wrapped around both pulley 962 and 964 such that, when the motor 960 is actuated the belt 968 causes the coupler 970 to rotate, which then rotates the hollow rotatable housing 950.

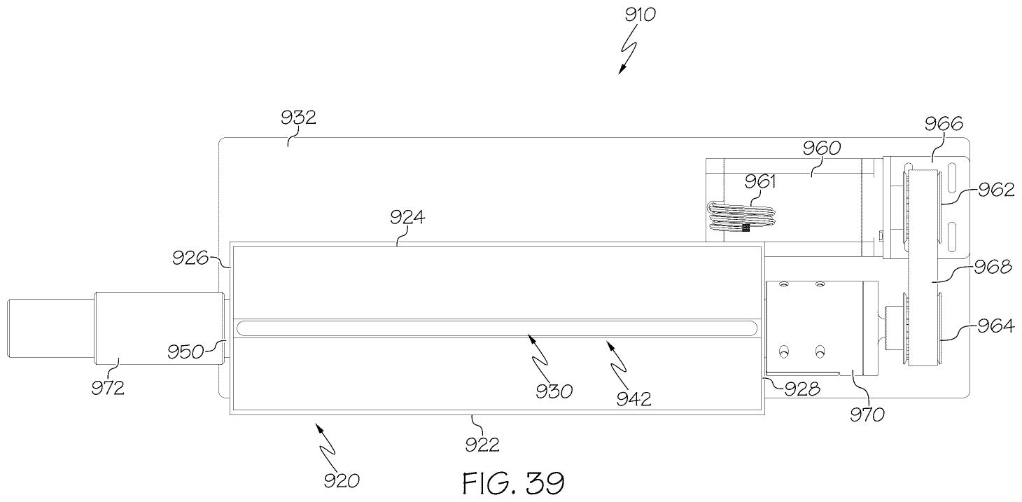

Referring now to FIG. 39, a sealed or closed position of the hollow rotatable housing 950 is illustrated. In this closed position, particulates falling into the chute 920 cannot enter the hollow rotatable housing 950, because none of the plurality of spaced-apart openings 952 are positioned along the longitudinal opening 942. The motor 960 can be used to control this closed position. During typical operation, the motor 960 is actuated and the inner rotatable tube 950 is spinning and collecting falling particulates. The external vacuum system can be engaged at set time intervals, or left on, and the collected particulates are evacuated out of the vacuum inlet 972. Once operation is over, the motor 960 will stop the rotation of the inner rotatable tube 950 and, if desired, can “close” the system as depicted in FIG. 39.

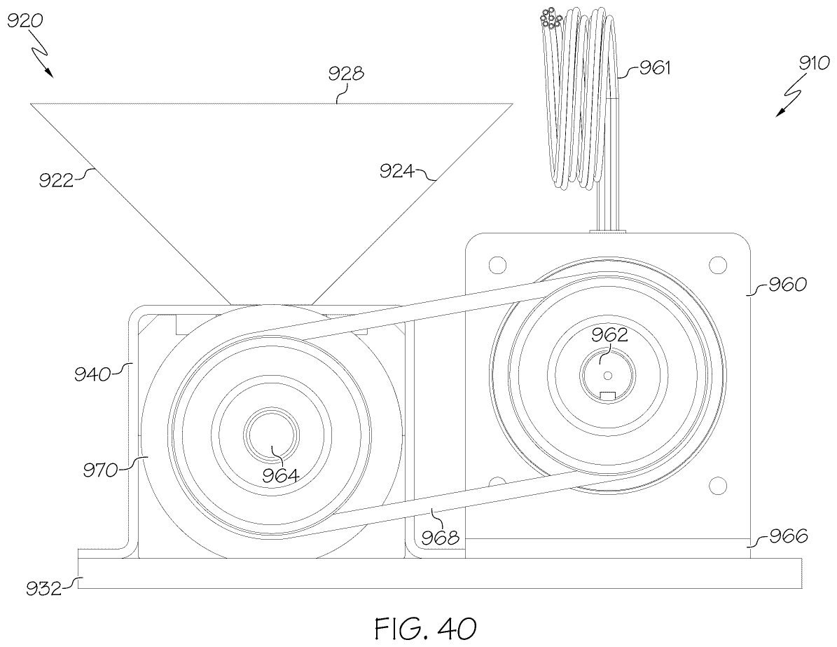

Referring now to FIG. 40, the coupler 970 and the second pulley 964 are shown along with the motor 960 and the first pulley 962. FIG. 40 illustrates a design difference compared to earlier embodiments, in which the motor and the coupler were linearly mechanically connected (see FIG. 1, for example). However, as depicted in this eighth alternative embodiment, the coupler 970 and the motor 960 are not linearly connected, but instead connected by a belt and pulley system. This allows for a designer to use different motor types and/or sizes, to accommodate the needs of the system. The belt 968 can be wrapped around pulleys of different sizes, providing more flexibility when designing or testing the collection system 910.

FIG. 41 illustrates an exploded view of this eighth alternative embodiment particulate collection system 910. The plurality of spaced-apart openings 952 can be seen on the hollow rotatable housing 950, along with the cradle 955 and the plurality of fillers 957.

As used herein, the term “proximal” can have a meaning of closely positioning one physical object with a second physical object, such that the two objects are perhaps adjacent to one another, although it is not necessarily required that there be no third object positioned therebetween. In the technology disclosed herein, there may be instances in which a “male locating structure” is to be positioned “proximal” to a “female locating structure.” In general, this could mean that the two (male and female) structures are to be physically abutting one another, or this could mean that they are “mated” to one another by way of a particular size and shape that essentially keeps one structure oriented in a predetermined direction and at an X-Y (e.g., horizontal and vertical) position with respect to one another, regardless as to whether the two (male and female) structures actually touch one another along a continuous surface. Or, two structures of any size and shape (whether male, female, or otherwise in shape) may be located somewhat near one another, regardless if they physically abut one another or not; such a relationship could still be termed “proximal.” Or, two or more possible locations for a particular point can be specified in relation to a precise attribute of a physical object, such as being “near” or “at” the end of a stick; all of those possible near/at locations could be deemed “proximal” to the end of that stick. Moreover, the term “proximal” can also have a meaning that relates strictly to a single object, in which the single object may have two ends, and the “distal end” is the end that is positioned somewhat farther away from a subject point (or area) of reference, and the “proximal end” is the other end, which would be positioned somewhat closer to that same subject point (or area) of reference.

It will be understood that the various components that are described and/or illustrated herein can be fabricated in various ways, including in multiple parts or as a unitary part for each of these components, without departing from the principles of the technology disclosed herein. For example, a component that is included as a recited element of a claim hereinbelow may be fabricated as a unitary part; or that component may be fabricated as a combined structure of several individual parts that are assembled together. But that “multi-part component” will still fall within the scope of the claimed, recited element for infringement purposes of claim interpretation, even if it appears that the claimed, recited element is described and illustrated herein only as a unitary structure.

All documents cited in the Background and in the Detailed Description are, in relevant part, incorporated herein by reference; the citation of any document is not to be construed as an admission that it is prior art with respect to the technology disclosed herein.

The foregoing description of a preferred embodiment has been presented for purposes of illustration and description. It is not intended to be exhaustive or to limit the technology disclosed herein to the precise form disclosed, and the technology disclosed herein may be further modified within the spirit and scope of this disclosure. Any examples described or illustrated herein are intended as non-limiting examples, and many modifications or variations of the examples, or of the preferred embodiment(s), are possible in light of the above teachings, without departing from the spirit and scope of the technology disclosed herein. The embodiment(s) was chosen and described in order to illustrate the principles of the technology disclosed herein and its practical application to thereby enable one of ordinary skill in the art to utilize the technology disclosed herein in various embodiments and with various modifications as are suited to particular uses contemplated. This application is therefore intended to cover any variations, uses, or adaptations of the technology disclosed herein using its general principles. Further, this application is intended to cover such departures from the present disclosure as come within known or customary practice in the art to which this technology disclosed herein pertains and which fall within the limits of the appended claims.

1. A particulate collection system, comprising:
a hollow stationary enclosure exhibiting at least one longitudinal opening;
a hollow rotatable housing exhibiting at least one opening along a wall of the hollow rotatable housing, the hollow rotatable housing being positioned inside the hollow stationary enclosure;
a chute exhibiting a bottom opening, the bottom opening of the chute being mounted proximal to the at least one opening of the hollow stationary enclosure;
a motor mount;
a motor secured to the motor mount, the motor exhibiting a port for connection to an external power source;
a hose mount that is proximal to an open first end of the hollow rotatable housing, the hose mount allowing for a connection with an external hose to create a pneumatic communication with an external vacuum system; and
the motor being mounted proximal to a second, opposite end of the hollow rotatable housing, the motor being in mechanical communication with the hollow rotatable housing.

2. The particulate collection system of claim 1, wherein:
when the motor is actuated, the motor rotates the hollow rotatable housing.

3. The particulate collection system of claim 2, further comprising:
an external vacuum system; and
a hose that has a first end and a second, opposite end;
wherein:
the first end of the hose is connected to the hose mount;
the second end of the hose is connected to the external vacuum system, thereby creating a pneumatic system between the open first end of the hollow rotatable housing and the external vacuum system.

4. The particulate collection system of claim 3, wherein:
during operation, when particulates enter the chute, the particulates drop through the at least one longitudinal opening of the hollow stationary enclosure and the at least one opening of the hollow rotatable housing;
the rotation of the hollow rotatable housing mixes the particulates; and
the vacuum flow of the external vacuum system then removes the particulates from the hollow rotatable housing, through the hose.

5. The particulate collection system of claim 4, wherein:
the external vacuum system comprises at least one of:
a central vacuum system; and
a portable vacuum.

6. The particulate collection system of claim 1, wherein:
the at least one opening of the hollow rotatable housing comprises at least one of:
a plurality of spaced-apart slanted openings;
a plurality of spaced-apart circular openings; and
a plurality of spaced-apart triangular openings.

7. The particulate collection system of claim 6, wherein:
the at least one opening of the hollow rotatable housing comprises a plurality of openings that are located at various positions along both an elongated length and a cross-sectional wall of the hollow rotatable housing; and
as the hollow rotatable housing is rotated, then at least one of the plurality of openings appears at every position along an effective elongated length at one of the rotational positions during each complete rotation of the hollow rotatable housing, in which the effective elongated length does not include mounting positions.

8. The particulate collection system of claim 2, further comprising:
an inlet adapter secured on an inlet support;
the inlet adapter is positioned between the hose and the first end;
wherein: the rotatable housing rotates inside the inlet.

9. The particulate collection system of claim 1, further comprising:
a plurality of supports and the motor mount are secured along the length of an elongated base; and
the hollow stationary enclosure is positioned on the plurality of supports.

10. The particulate collection system of claim 1, wherein: the rotatable housing comprises an elongated hollow cylinder that exhibits a plurality of openings along a cylindrical wall.

11. The particulate collection system of claim 1, wherein:
(a) the hollow stationary enclosure exhibits a cross-sectional shape of a square; or
(b) the hollow stationary enclosure exhibits a cross-sectional shape of a circle.

12. The particulate collection system of claim 1, wherein: the external vacuum system generates a high vacuum velocity, while simultaneously reducing the volumetric flow rate of air required to vacuum particulates out of the particulate collection system.

13.-21. (canceled)

22. A method for collecting particulates, the method comprising:
providing a particulate collection system, including:
a hollow stationary enclosure;
a hollow rotatable housing positioned inside the hollow stationary enclosure;
a motor mount;
a motor secured to the motor mount, the motor being connected to an external power source;
a hose mounted proximal to an open first end of the hollow rotatable housing, in which the hose is in pneumatic communication with an external vacuum system;
the motor mounted proximal to a second, opposite end of the hollow rotatable housing, and the motor is in mechanical communication with the hollow rotatable housing;
the hollow stationary enclosure exhibiting at least one longitudinal opening on an upper portion of the hollow stationary enclosure; and
the hollow rotatable housing exhibiting a plurality of spaced-apart openings along the wall of the hollow rotatable housing;
actuating the external vacuum system;
actuating the motor;
rotating, by use of the motor, the hollow rotatable housing;
collecting, using the hollow rotatable housing, particulates that drop through the plurality of longitudinal openings of the hollow stationary enclosure and that also drop through the plurality of spaced-apart openings of the hollow rotatable housing; and
removing, using the external vacuum system, the collected particulates through the hose.

23. The method of claim 22, further comprising:
providing a chute exhibiting a bottom opening;
mounting the chute proximal to the plurality of longitudinal openings of the hollow stationary enclosure, such that the bottom opening is positioned above the plurality of longitudinal openings; and
during operation, particulates first travel through the chute and then drop through the at least one longitudinal opening of the hollow stationary enclosure.

24. The method of claim 22, wherein, the external vacuum system comprises at least one of:
a central vacuum system; and
a portable vacuum.

25. The method of claim 22, further comprising:
providing a torque limiter and a coupler;
wherein:
the torque limiter is in mechanical communication with the motor and the coupler; and
the coupler is in mechanical communication with the hollow rotating inner tube.

26. The method of claim 22, wherein:
the hollow stationary enclosure exhibiting a first opening proximal to the first end of the hollow rotatable housing; and
the hollow stationary enclosure exhibiting a second opening proximal to the second end of the hollow rotatable housing.

27. The method of claim 23, further comprising:
providing an inlet adapter secured on an inlet support, and
the inlet adapter is positioned between the hose and the first end;
wherein: the rotatable housing rotates inside the inlet.

28. The method of claim 22, further comprising:
a plurality of supports and the motor mount are secured along the length of an elongated base; and
the hollow stationary enclosure is positioned on the plurality of supports.

29. The method of claim 22, wherein: the rotatable housing comprises an elongated hollow cylinder.

30.-40. (canceled)

41. A particulate collection system, comprising:
a chute exhibiting a bottom opening, the bottom opening of the chute being mounted proximal to a hollow stationary enclosure;
a hollow rotatable housing exhibiting at least one opening along a wall of the hollow rotatable housing, the hollow rotatable housing being positioned inside the hollow stationary enclosure;
a motor secured to a motor mount, the motor exhibiting a connection to an external power source;
a coupler mounted proximal to a second, opposite end of the hollow rotatable housing, the coupler being in mechanical communication with the hollow rotatable housing and the motor;
a hose mount that is proximal to an open first end of the hollow rotatable housing, the hose mount allowing for a connection with an external hose to create a pneumatic communication with an external vacuum system; and
the hollow rotatable housing can be rotated to a position that seals the bottom opening of the chute, such that particulates can not drop through the at least one opening along a wall of the hollow rotatable housing.

42. The particulate collection system of claim 41, further comprising:
a first pulley in mechanical communication with the motor;
a second pulley in mechanical communication with the coupler; and
a belt that is in mechanical communication with the first pulley and the second pulley, such that when the motor is actuated, the belt rotates the coupler, and the coupler rotates the hollow rotatable housing.

43. The particulate collection system of claim 42, further comprising:
a cradle and a plurality of fillers, in which the hollow rotatable housing is positioned on the cradle, and the plurality of fillers are positioned on top of the hollow rotatable housing; and
the hollow stationary enclosure is positioned over the cradle, the hollow rotatable housing, and the plurality of fillers, and then mounted to an elongated base, thereby securing the hollow rotatable housing.
